(19) United States
(12) Patent Application Publication
(10) Pub. No.: US 2026/0001347 A1
(43) Pub. Date: Jan. 1, 2026

(54) IMAGE PROCESSING APPARATUS, RECORDING APPARATUS, NON-TRANSITORY COMPUTER-READABLE STORAGE MEDIUM, AND IMAGE PROCESSING METHOD

(71) Applicant: CANON KABUSHIKI KAISHA, Tokyo (JP)

(72) Inventors: YUTO KAJIWARA, Kanagawa (JP); YUGO MOCHIZUKI, Kanagawa (JP)

(21) Appl. No.: 19/246,449

(22) Filed: Jun. 23, 2025

(30) Foreign Application Priority Data
Jul. 1, 2024 (JP) 2024-106279

(51) Int. Cl. B41J 2/21

(52) U.S. Cl. CPC B41J 2/2117

(57) ABSTRACT

An image processing apparatus comprises at least one memory storing instructions; and at least one processor, that upon execution of the stored instructions, is configured to operate as an acquisition unit configured to acquire data of an image; and a generation unit configured to generate color separation data based on the data of the image, the color separation data being used to record the image using a first ink for forming a surface layer of the image, a first reaction liquid that reacts with the first ink, a second ink for forming an undercoat layer of the image, and a second reaction liquid that has a different reactivity from the first reaction liquid and reacts with the second ink.

### BACKGROUND

### Field of the Technology

The present disclosure relates to an image processing apparatus, a recording apparatus, a non-transitory computer-readable storage medium, and an image processing method.

### Description of the Related Art

A recording apparatus that records an image on a recording medium by applying thereto a recording material such as ink is known. Such a recording apparatus records an image using a reaction liquid that reacts with a colorant contained in the ink to aggregate the ink.

Japanese Patent Laid-Open No. 2019-42982 discloses a technique for recording an image by applying ink onto a reaction liquid adhered to a recording medium.

However, since the image recorded on the recording medium is viewed from various positions and the surface of the recording medium has various shapes, the technique according to Japanese Patent Laid-Open No. 2019-42982 may not be able to appropriately record an image depending on the viewing position or the surface of the recording medium.

### SUMMARY

The present disclosure in its first aspect provides an image processing apparatus comprising: at least one memory storing instructions; and at least one processor, that upon execution of the stored instructions, is configured to operate as: an acquisition unit configured to acquire data of an image; and a generation unit configured to generate color separation data based on the data of the image, the color separation data being used to record the image using a first ink for forming a surface layer of the image, a first reaction liquid that reacts with the first ink, a second ink for forming an undercoat layer of the image, and a second reaction liquid that has a different reactivity from the first reaction liquid and reacts with the second ink.

The present disclosure in its second aspect provides a non-transitory computer-readable storage medium storing a computer program that, when read and executed by a computer, causes the computer to function as: an acquisition unit configured to acquire data of an image; and a generation unit configured to generate color separation data based on the data of the image, the color separation data being used to record the image using a first ink for forming a surface layer of the image, a first reaction liquid that reacts with the first ink, a second ink for forming an undercoat layer of the image, and a second reaction liquid that has a different reactivity from the first reaction liquid and reacts with the second ink.

The present disclosure in its third aspect provides an image processing method comprising: acquiring data of an image; and generating color separation data based on the data of the image, the color separation data being used to record the image using a first ink for forming a surface layer of the image, a first reaction liquid that reacts with the first ink, a second ink for forming an undercoat layer of the image, and a second reaction liquid that has a different reactivity from the first reaction liquid and reacts with the second ink.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a perspective view of the external appearance of a recording apparatus according to embodiments.

FIG. 2 is a side cross-sectional view of the body of the recording apparatus according to the embodiments, and is a schematic diagram of the vicinity of a heating unit.

FIG. 3 is a plan view of a recording head according to the embodiments.

FIG. 4A is a diagram illustrating the reflection of light when the surface smoothness of an ink layer on a recording medium is low.

FIG. 4B is a diagram illustrating the reflection of light when the surface smoothness of an ink layer on a recording medium is high.

FIG. 5 is a block diagram showing the configuration of a control system of the recording apparatus according to the embodiments.

FIG. 6 is a flowchart showing the flow of image processing according to the embodiments.

FIG. 7A is a diagram illustrating calculation processing performed on data of a W image, which is an undercoat image according to the embodiments, using a one-dimensional lookup table (LUT).

FIG. 7B is a diagram illustrating calculation processing performed on data of an RGB image, which is a color development image according to the embodiments, using a one-dimensional lookup table (LUT).

FIG. 8A is a diagram illustrating pass masks for scanning, which are used to perform pass division processing on dot assignment data for preceding ejection.

FIG. 8B is a schematic diagram showing the process of performing recording scans using the pass masks shown in FIG. 8A.

FIG. 9A is a diagram illustrating pass masks for scanning, which are used to perform pass division processing on dot assignment data for subsequent ejection.

FIG. 9B is a schematic diagram showing the process of performing recording scans using the pass masks shown in FIG. 9A.

FIG. 10 is a schematic diagram illustrating ejection ports that perform recording, among an array of ejection ports provided in a recording head according to a first embodiment.

FIG. 11A is a diagram illustrating the structure of an ink layer on a recording medium when image formation is performed using color ink, white ink, and two types of reaction liquids in the first embodiment.

FIG. 11B is a table showing a relationship between symbols indicating the regions in FIG. 11A and the presence or absence of the ink layers.

FIG. 12A is a diagram illustrating a method of setting attribute data in a case where a small amount of post-printed color ink is used and undercoat layers are exposed according to the first embodiment.

FIG. 12B is a diagram illustrating the setting of attribute data in a case where the attribute data is set with multiple values.

FIG. 13 is a diagram illustrating a case where there are three or more ink layers according to the first embodiment.

FIG. 14A is a diagram illustrating an ink layer structure on a recording medium according to a second embodiment.

FIG. 14B is a diagram illustrating another example of an ink layer structure on a recording medium according to the second embodiment.

FIG. 15A is a diagram in which examples of ejection ports that perform recording at least once on a recording medium after pass division processing are indicated by hatching according to the second embodiment.

FIG. 15B is a diagram in which other examples of ejection ports that perform recording at least once on a recording medium after pass division processing are indicated by hatching according to the second embodiment.

FIG. 15C is a diagram in which other examples of ejection ports that perform recording at least once on a recording medium after pass division processing are indicated by hatching.

FIG. 16 is a diagram showing a UI screen of an application according to the second embodiment.

FIG. 17 is a block diagram illustrating the hardware configuration of a computer.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The present disclosure provides a technique for appropriately recording an image in accordance with the viewing position or the shape of the surface of the recording medium.

### First Embodiment

Hereinafter, an embodiment will be described with reference to the drawings. In the following, a recording apparatus employing an inkjet recording method will be described as an example. The recording apparatus may be, for example, a single-function printer having only an image recording function, or a multi-function printer having multiple functions such as a FAX function and a scanner function in addition to the recording function. Alternatively, the recording apparatus may be, for example, a manufacturing apparatus for producing color filters, electronic devices, optical devices, microstructures, etc., using a predetermined recording method.

### <Configuration of Inkjet Recording Apparatus>

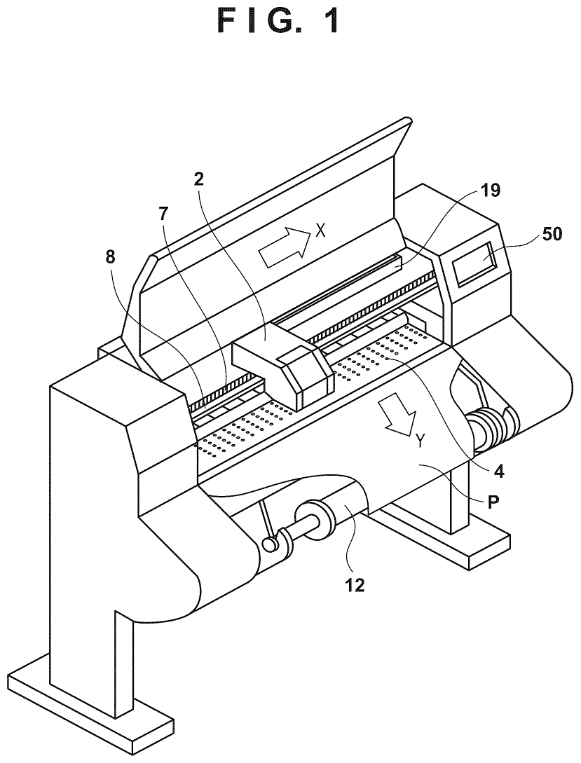

FIG. 1 is a perspective view of the external appearance of an inkjet recording apparatus (also referred to as a recording apparatus or a printer) according to embodiments. This is a so-called serial scanning printer, in which a recording head scans in an X direction (scanning direction), orthogonal to a Y direction (conveying direction) of a recording medium P, to record an image on the recording medium P. The recording apparatus according to the present embodiment records an image with a plurality of layers, at least some of which are laminated ink layers. The term “image” may include both an image itself and image data.

With reference to FIG. 1, the configuration of the inkjet recording apparatus and the outline of the operation thereof during recording will be described. First, the recording medium P is conveyed in the Y direction by a spool 6 that holds the recording medium P, the spool 6 being driven via gears by a conveyance roller driven by a conveyance motor (not shown).

Meanwhile, when the conveyed recording medium P is at a predetermined position, a carriage motor (not shown) causes a carriage unit 2 to perform reciprocating scanning (reciprocating movement) along a guide shaft 8 extending in the X direction. During this scanning process, ink ejection is performed from the ejection ports of the recording head (described later) attachable to the carriage unit 2, at timings based on position signals obtained from an encoder 7, thereby recording a band of a fixed width corresponding to the arrangement range of the ejection ports. The scanning speed of the carriage unit 2 is variable and can scan at 10 to 70 inches per second. The printing resolution is also variable, and ejection can be performed at 300 to 2400 dpi. In the present embodiment, for example, the carriage unit 2 is configured to scan at a scanning speed of 40 inches per second and perform ejection at a recording resolution of 1200 dpi (at intervals of 1/1200 inch). Thereafter, the recording medium P is conveyed, and recording is performed for the next bandwidth. Although details will be described later, each ejection port of the recording head attachable to the carriage unit 2 is provided with a recording element for ejecting ink in the form of droplets. A flexible wiring board 19 is provided to supply driving pulses for driving the recording element and head temperature adjustment signals.

The driving force from the carriage motor to the carriage unit 2 can be transmitted using a carriage belt. However, instead of a carriage belt, other driving means can also be used, such as a mechanism including a lead screw, which is rotated by the carriage motor and extends in the X direction, and an engagement part provided on the carriage unit 2, which engages with grooves of the lead screw.

The supplied recording medium P is conveyed while being held between a paper feed roller and a pinch roller and guided to a recording position (scanning region of the recording head) on a platen 4. When the recording apparatus is in a normal idle state, the face surface of the recording head is capped, and therefore the cap is opened prior to recording to make the recording head or the carriage unit 2 capable of scanning. Thereafter, when data for one scan is accumulated in a buffer, the carriage motor causes the carriage unit 2 to perform scanning, and recording is performed as described above.

A UI screen 50 allows the user to input and confirm instructions to stop the recording operation, information regarding the recording medium P, and so on. In addition, the user can individually specify various recording conditions, such as the setting of the reaction liquid application amount level. UI stands for User Interface.

### <Heating Unit>

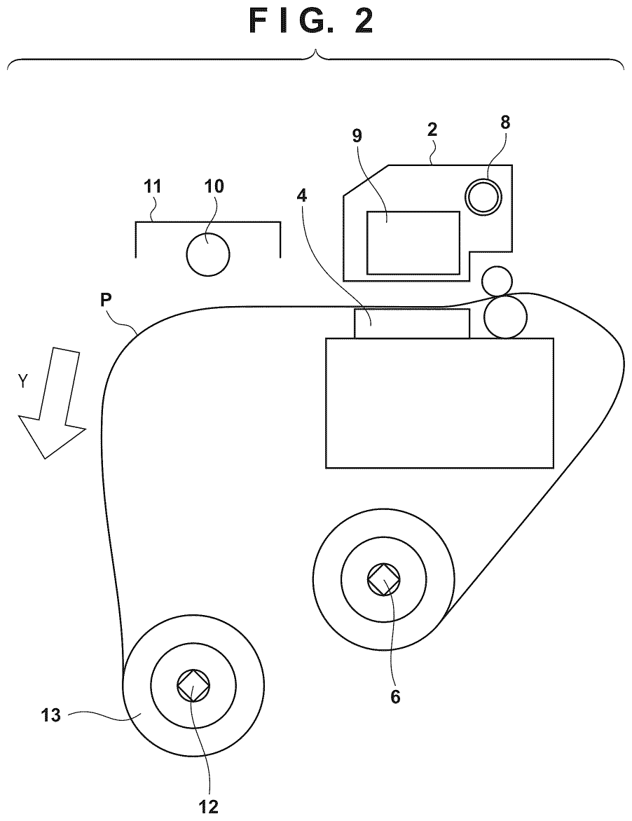

FIG. 2 is a side cross-sectional view of the body of the recording apparatus according to the embodiments, and is a schematic diagram of the vicinity of a heating unit. Although not shown in FIG. 1, the recording apparatus includes a heating unit that heats and dries the ink applied to the recording medium P after the recording operation completes. The heating unit has the function of drying the ink, and the function of heating water-soluble resin microparticles, which will be described later, thereby forming a film. These water-soluble resin microparticles are a type of resin that forms a film when heated after being applied to the recording medium P, thereby improving the abrasion resistance of the image.

A heater 10 is supported by a frame (not shown) and is disposed in a curing region in order to dry the liquid ink on the recording medium P with heat. The curing region may be located downstream in the sub-scanning direction (Y direction) from the position where a recording head 9, attached to the carriage unit 2, reciprocally performs scanning in the main scanning direction X. The heater 10 is covered by a heater cover 11. The heater cover 11 has the function of efficiently radiating the heat from the heater 10 onto the recording medium P, and the function of protecting the heater 10. Note that, in this specification, the “heating unit” includes the heater 10 and the heater cover 11.

The recording medium P, wound around the spool 6, is conveyed while an image is recorded on it by the recording head 9, and is thereafter wound up by the spool 12 to form a rolled take-up medium 13. The heater 10 may be a sheathed heater, a halogen heater, or the like, and is not particularly limited.

In the recording method according to the present embodiment, the heating temperature of the heating unit in the curing region described above may be higher than or equal to the minimum film-forming temperature of the water-soluble resin microparticles. The heating unit needs to evaporate most of the liquid components, such as water-soluble organic solvents, in the ink during heating. Therefore, the heating unit needs to be configured to heat for a duration longer than or equal to the heating time required to supply the energy necessary for evaporating most of the liquid components. Thus, the heating unit needs to be designed considering film-forming properties, evaporation of liquid components, productivity of printed material, and the heat resistance of the recording medium P.

Note that, as a heating means of the heating unit in the curing region, hot air blowing from above or contact-type heat conduction heater heating from below the recording medium may be employed. In the present embodiment shown in FIG. 2, the heating unit in the curing region is provided at one location, but as long as the measured temperature indicated by a radiation thermometer (not shown) on the recording medium P does not exceed the set heating temperature, the heating unit may be provided at each of two or more locations and used together.

### <Configuration of Recording Head>

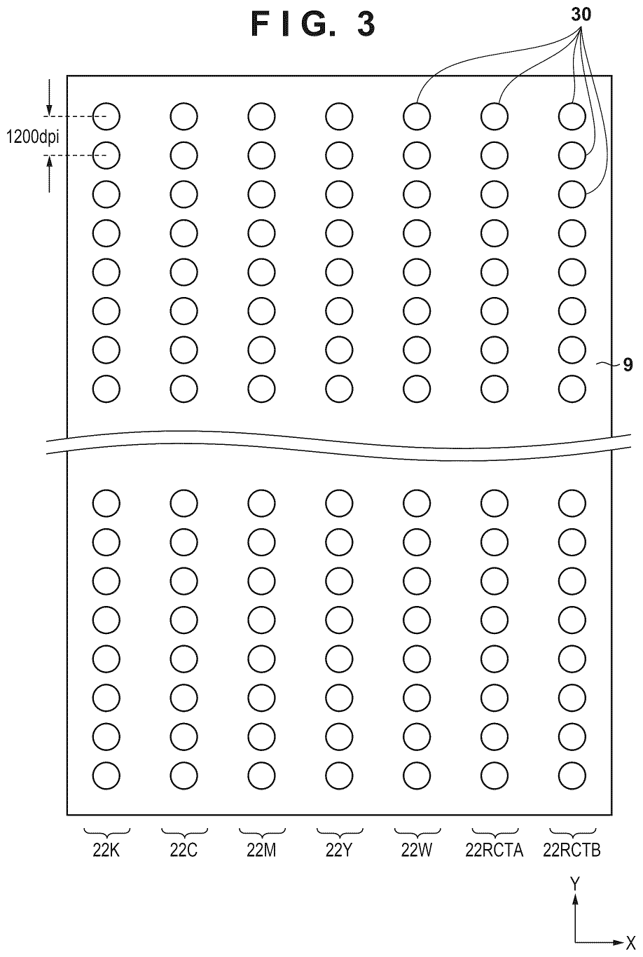

FIG. 3 is a plan view of the recording head 9 according to the embodiments. The recording head 9 includes a plurality of ejection port arrays in each of which a plurality of ejection ports 30 for ejecting ink are arranged in the Y direction. The recording head 9 includes an ejection port array 22K, an ejection port array 22C, an ejection port array 22M, an ejection port array 22Y, and an ejection port array 22W. The ejection port array 22K includes a plurality of ejection ports 30 that eject black ink (K). The ejection port array 22C includes a plurality of ejection ports 30 that eject cyan ink (C). The ejection port array 22M includes a plurality of ejection ports 30 that eject magenta ink (M). The ejection port array 22Y includes a plurality of ejection ports 30 that eject yellow ink (Y). The ejection port array 22W includes a plurality of ejection ports 30 that eject white ink (W). The black ink (K), cyan ink (C), magenta ink (M), yellow ink (Y), and white ink (W) each contain a colorant. Hereinafter, for simplicity, these inks containing colorants are referred to as colorant inks. Among the colorant inks, the inks excluding the white ink are also referred to as color inks. The color inks are examples of color development inks. The white ink is an example of an undercoat ink.

The recording head 9 includes an ejection port array 22RCTA that ejects reaction liquid A (RCTA, also referred to as a reactor A) and an ejection port array 22RCTB that ejects reaction liquid B (RCTB, also referred to as a reactor B). Here, the reaction liquid A and the reaction liquid B react with the solid components contained in the ink, such as colorants and resin microparticles, upon contact with the ink, promoting their aggregation, thereby acting as an auxiliary agent in image recording. The reaction liquid A and the reaction liquid B do not contain a colorant. The specific contents of the ink and the reaction liquids will be described later.

The ejection port array 22K, the ejection port array 22C, the ejection port array 22M, the ejection port array 22Y, and the ejection port array 22W are arranged in this order from left to right in the X direction. Each ejection port array has 1280 ejection ports 30 that eject the corresponding recording material. The ejection ports 30 are arranged in the Y direction (array direction) at a density of 1200 dpi. Note that, in the present embodiment, the ejection amount of the recording material ejected at one time from one ejection port 30 is approximately 4.5 pl. The ejection port arrays 22K, 22C, 22M, 22Y, 22W, 22RCTA, and 22RCTB are each connected to a tank (not shown) that stores the corresponding recording material, and the recording materials are supplied from the tanks. Note that the recording head 9 and the recording material tanks may be integrally formed or may be configured to be separable.

### <Recording Medium>

The recording apparatus according to the present embodiment performs recording on a low-permeability recording medium that is resistant to moisture penetration. Here, the low-permeability recording medium mentioned above is a medium that has no water absorption or extremely low water absorption. Therefore, water-based ink containing no organic solvent is repelled by the low-permeability recording medium and cannot form an image. On the other hand, the low-permeability recording medium has excellent water resistance and weather resistance, making it suitable as a medium for forming printed material to be used outdoors. Typically, a recording medium with a water contact angle of 45° or more at 25° C. is used as the low-permeability recording medium. Alternatively, a recording medium with a water contact angle of 60° or more at 25° C. may be used as the low-permeability recording medium.

Examples of low-permeability recording media include a recording medium with a plastic layer formed on the outermost surface of the base material, a recording medium having no ink-receiving layer formed on the base material, and a sheet, a film, and a banner made of glass, YUPO, plastic, or the like. Examples of coated plastics include polyvinyl chloride, polyethylene terephthalate, polycarbonate, polystyrene, polyurethane, polyethylene, and polypropylene. These low-permeability recording media have excellent water resistance, light resistance, and abrasion resistance, and therefore they are generally used to record printed matter for outdoor display.

As an example of a method for evaluating the permeability of a recording medium, the well-known Bristow method can be used. In the Bristow method, a predetermined amount of ink is injected into a holding container with an opening slit of a predetermined size. Thereafter, through the slit, the ink is brought into contact with the recording medium, which has been processed into a strip and wound around a disk, and the disk is rotated while keeping the position of the holding container fixed, in order to measure the area (length) of the ink band transferred to the recording medium. The transfer amount per unit area per second (ml/m²) can be calculated from the area of this ink band. In the present embodiment, a recording medium with an ink transfer amount (water absorption amount) of less than 10 ml/m² in 30 msec according to the Bristow method is considered a low-permeability recording medium.

### <Ink Composition>

The details of each ink constituting the ink set used in the present embodiment will be described. Hereinafter, unless otherwise specified, “parts” and “%” are based on mass. The composition of each ink will be described in detail below. The colorant inks (C, M, Y, K, and W) used in the present embodiment use black-based, cyan-based, magenta-based, yellow-based, and white-based colorant pigments as colorants, respectively. These colorant pigments are each prepared as a dispersion solution in an aqueous solution and thereafter blended with other predetermined material components to prepare the ink.

The colorant inks (C, M, Y, K, and W), the reaction liquid A (RCTA), and the reaction liquid B (RCTB) used in the present embodiment all contain water-soluble organic solvents. From the standpoint of wettability and moisturizing properties of the face surface of the recording head 9, the boiling point of the water-soluble organic solvent may be in the range of 150° C. to 300° C., inclusive. From the standpoint of functioning as a film-forming aid for resin microparticles and the swelling solubility of the recording medium with a resin layer, the water-soluble organic solvent may be a ketone compound such as acetone or cyclohexanone, or a propylene glycol derivative such as tetraethylene glycol dimethyl ether. From the same standpoint, the water-soluble organic solvent may be a heterocyclic compound having a lactam structure, such as N-methyl-pyrrolidone or 2-pyrrolidone.

From the standpoint of ejection performance, the content of the water-soluble organic solvent may be in the range of 3 wt % to 30 wt %, inclusive. The water-soluble organic solvent may be, for example, an alkyl alcohol having one to four carbon atoms, such as methyl alcohol, ethyl alcohol, n-propyl alcohol, isopropyl alcohol, n-butyl alcohol, sec-butyl alcohol, or tert-butyl alcohol. The water-soluble organic solvent may be an amide such as dimethylformamide or dimethylacetamide. The water-soluble organic solvent may be a ketone or keto-alcohol such as acetone or diacetone alcohol. The water-soluble organic solvent may be an ether such as tetrahydrofuran or dioxane. The water-soluble organic solvent may be a polyalkylene glycol such as polyethylene glycol or polypropylene glycol. The water-soluble organic solvent may be an alkylene glycol containing two to six carbon atoms in the alkylene group, such as ethylene glycol, propylene glycol, butylene glycol, triethylene glycol, 1,2,6-hexanetriol, thiodiglycol, hexylene glycol, or diethylene glycol. The water-soluble organic solvent may be a lower alkyl ether of a polyhydric alcohol, such as polyethylene glycol monomethyl ether acetate, glycerin, ethylene glycol monomethyl (or ethyl) ether, diethylene glycol methyl (or ethyl) ether, or triethylene glycol monomethyl (or ethyl) ether. The water-soluble organic solvent may be a polyhydric alcohol such as trimethylolpropane or trimethylolethane. The water-soluble organic solvent may be N-methyl-2-pyrrolidone, 2-pyrrolidone, or 1,3-dimethyl-2-imidazolidinone. The above-mentioned water-soluble organic solvents may be used alone or as a mixture.

In addition, deionized water may be used as the water. Note that the contents of the water-soluble organic solvents in the reaction liquid A (RCTA) and the reaction liquid B (RCTB) are not particularly limited, but the colorant inks (C, M, Y, K, and W) may contain a surfactant, a defoaming agent, a preservative, an antifungal agent, and so on in addition to the components mentioned above in order to achieve desired physical properties as needed.

The colorant inks (C, M, Y, K, and W), the reaction liquid A (RCTA), and the reaction liquid B (RCTB) used in the present embodiment all contain a surfactant. The surfactant serves as a penetrant to improve the permeability of the inks into recording media specifically designed for inkjet printing. The higher the amount of surfactant added, the greater the effect of lowering the surface tension of the inks, thereby enhancing their wettability and permeability to the recording medium. In the present embodiment, a small amount of a surfactant such as an ethylene oxide adduct of acetylene glycol is added, adjusting the surface tension of each ink to 30 dyn/cm or less, and the difference in surface tension among the inks to within 2 dyn/cm. More specifically, all of the inks are adjusted to have a surface tension of approximately 22 to 24 dyn/cm. Surface tension is measured using a fully automatic surface tensiometer CBVP-Z (manufactured by Kyowa Interface Science Co., Ltd.). Note that the measuring apparatus is not limited to the example above as long as it can measure the surface tension of the ink.

The pH of each ink in the present embodiment is stable on the alkaline side. The pH value of each ink is, for example, not lower than 8.5 and not higher than 9.5. From the standpoint of preventing the elution or degradation of components that come into contact with each ink within the recording apparatus or recording head, as well as preventing a decrease in the solubility of dispersed resins in the ink, the pH of each ink may be in the range of 7.0 to 10.0, inclusive. The pH is measured using a pH meter (Model F-52) manufactured by HORIBA, Ltd. The measuring device is not limited to the example above as long as it can measure the pH of each ink.

The colorant inks may further include light cyan ink (Lc), light magenta ink (Lm), gray ink (Gy), red ink (R), orange ink (Or), green ink (G), violet ink (V), metallic ink (Mt), and so on.

### <Water-Soluble Resin Microparticles>

The water-soluble resin microparticles according to the present embodiment will be described. Each of the colorant inks (C, M, Y, K, and W) according to the present embodiment contains water-soluble resin microparticles to adhere the colorant to the recording medium and improve the abrasion resistance (fixability) of the recorded image. The resin microparticles are melted by heat, and a film is formed from the resin microparticles and the solvent contained in the ink is dried by the heater. In the present embodiment, “resin microparticles” refer to polymer microparticles present in a dispersed state in water.

The resin microparticles may be acrylic resin microparticles synthesized by, for example, emulsion polymerization of monomers such as (meth)acrylic acid alkyl esters and (meth)acrylic acid alkyl amides. The resin microparticles may also be styrene-acrylic resin resin microparticles synthesized by, for example, emulsion polymerization of monomers such as (meth)acrylic acid alkyl esters, (meth)acrylic acid alkyl amides, and styrene. The resin microparticles may also be polyethylene resin microparticles, polypropylene resin microparticles, polyurethane resin microparticles, styrene-butadiene resin microparticles, or the like. The resin microparticles may also be core-shell type resin microparticles in which the core and shell parts constituting the resin microparticles have different polymer compositions, or resin microparticles obtained by emulsion polymerization around seed particles, such as acrylic microparticles synthesized in advance in order to control particle diameter. The resin microparticles may also be hybrid type resin microparticles in which different resin microparticles, such as acrylic resin microparticles and urethane resin microparticles, are chemically bonded.

The “polymer microparticles present in a dispersed state in water” may be in the form of resin microparticles obtained by homopolymerizing or copolymerizing monomers having dissociable groups, so-called self-dispersing resin microparticle dispersions. Here, examples of dissociable groups include carboxyl groups, sulfonic acid groups, and phosphoric acid groups. Examples of monomers having dissociable groups include acrylic acid and methacrylic acid. Furthermore, the polymer microparticles may also be so-called emulsified dispersion type resin microparticle dispersions in which resin microparticles are dispersed by an emulsifier. The emulsifier may be a material having an anionic charge, regardless of low or high molecular weight.

Note that the water-soluble resin microparticles are not necessarily required to be contained in the colorant inks, and they may be included in a clear emulsion ink (Em) that is different from the colorant inks and the reaction liquids and does not contain a colorant.

### <Compositions of Reaction Liquids>

The reaction liquid A and the reaction liquid B according to the present embodiment will be described. The present embodiment employs a recording system that uses reaction liquids to insolubilize part or all of the solid components of the colorant inks, in order to address image issues such as bleeding and beading. In the present embodiment, the reaction means aggregating the solid components of the colorant inks or insolubilizing the solid components of the colorant inks. In addition, the present embodiment uses two different types of reaction liquids, which will be described below.

The reaction liquids may be, for example, solutions containing polyvalent metal ions (e.g., magnesium nitrate, magnesium chloride, aluminum sulfate, iron chloride, etc.) to insolubilize dissolved dyes, dispersed pigments, and resins. Such aggregation using cations may be the action of a system using a low molecular weight cationic polymer coagulant for charge neutralization of water-soluble resin microparticles and insolubilization of anionic soluble substances.

An example of another reaction system is an insolubilization system using a reaction liquid that utilizes pH differences. As described above, generally, color inks used in inkjet recording are mostly stable on the alkaline side due to the properties of their colorants. The pH of color inks is typically around 7 to 10, and from an industrial perspective and considering external environmental influences, it is often set around 8.5 to 9.5. To aggregate and solidify such color inks, an acidic solution can be mixed to change the pH, thereby disrupting the stable state and aggregating the dispersed components. A solution exhibiting acidity for this purpose can also be used as a reaction liquid.

The reaction liquid A and the reaction liquid B according to the present embodiment are adjusted to have different reactivities with the colorant inks (C, M, Y, K, and W). The reaction liquid A contains at least a cationic polymer as a reactive component. The cationic polymer contains many ionic polar groups in one polymer molecule and has a high charge density, making it highly capable of insolubilizing the solid components contained in the colorant inks. Since the cationic polymer has strong aggregation action, it enhances the aggregation of ink dots on the recording medium and suppresses the spreading of ink dots, so the reaction liquid A can reduce the surface smoothness of the printed matter. As a result, when the reaction liquid A is used for the ink of the surface layer, it can reduce the angle dependence of the recorded image, improving visibility. On the other hand, when the reaction liquid A is used for the ink of the internal layer, it can form a robust layer structure.

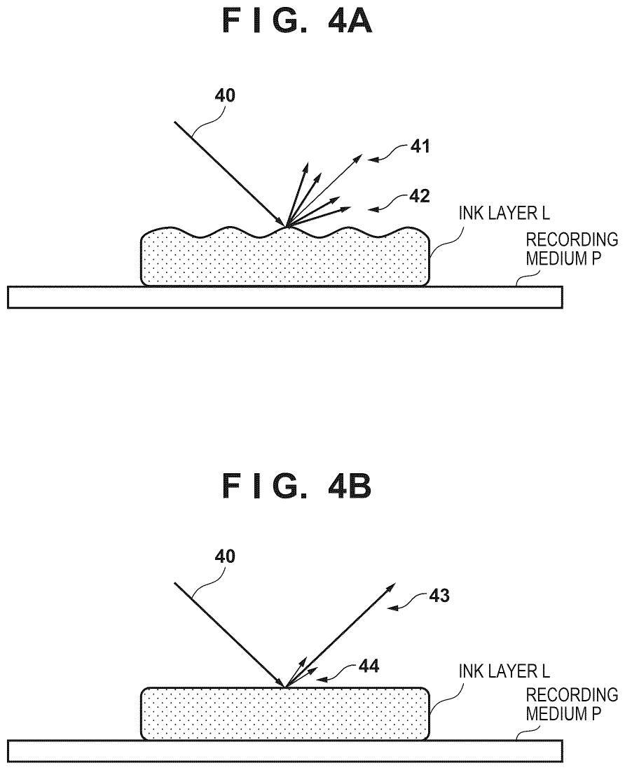

FIGS. 4A and 4B are diagrams illustrating the reflection of light depending on the difference in surface smoothness of an ink layer L on the recording medium P. The reflection of light on the recording medium P will be described with reference to FIGS. 4A and 4B.

FIG. 4A is a diagram illustrating the reflection of light when the surface smoothness of the ink layer L on the recording medium P is low. When the surface smoothness of the ink layer L is low, the proportion of reflected light relative to incident light 40 is low for specular reflected light 41 and high for diffuse reflected light 42. The small difference in the proportion between specular reflected light 41 and diffuse reflected light 42 reduces angle dependence. For example, in the case of outdoor poster display, lower angle dependence makes text information easier to read, resulting in higher visibility.

The Reaction liquid B contains at least a polyvalent metal salt as a reactive component. Compared to the reaction liquid A containing a cationic polymer, the reaction liquid B tends to have relatively weaker aggregation action, making it easier to control the aggregation state when mixed with the color inks. Since the reaction liquid B weakly aggregates the color inks, the color inks aggregate over a relatively long time. Therefore, with the reaction liquid B, ink dots tend to spread sufficiently on the recording medium. As a result, the reaction liquid B can increase the surface smoothness of the printed matter and improve its affinity with a recording medium having high surface smoothness.

FIG. 4B is a diagram illustrating the reflection of light when the surface smoothness of the ink layer L on the recording medium P is high. When the surface smoothness of the ink layer L is high, the proportion of reflected light relative to the incident light 40 is high for the specular reflected light 43 and low for the diffuse reflected light 44. For example, a light-transmissive recording medium such as a light-transmissive PET exhibits high surface smoothness and produces little diffuse reflected light due to its light-transmissive properties. This makes it possible to enhance the affinity between the ink and the recording medium by increasing the surface smoothness of the ink layer L. In particular, white ink is used for the undercoat regions, but if there is a significant difference in surface properties between the ink and the recording medium, it may cause a visual inconsistency at the boundary, leading to an unnatural appearance. Therefore, it is important to increase the surface smoothness of the ink layer L so that it closely resembles the surface texture of the recording medium. The surface smoothness can be evaluated by performing three-dimensional roughness measurements using a non-contact optical interferometer (product name: Vert Scan R5500G, manufactured by Ryoka Systems Inc.).

Here, the reaction liquid A induces a relatively strong reaction and is therefore also referred to as the strong reaction liquid, while the reaction liquid B induces a relatively weak reaction and is also referred to as the weak reaction liquid. In the present embodiment, the content of the reactive component may fall within the range of 0.1 to 90.0 wt %, inclusive, and may also fall within the range of 1.0 to 70.0 wt %, inclusive, based on the total mass of the composition contained in the reaction liquid. The reactivity can be varied not only by changing the type of the reactive component as described above, but also by altering the concentration of the reactive component and the pH value.

### <Laminated Structure of Ink Layer>

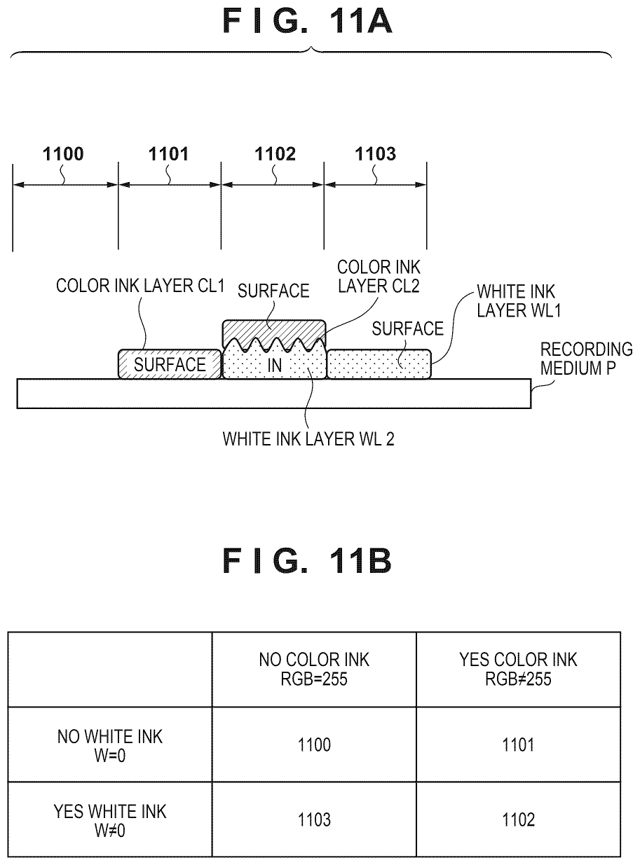

FIGS. 11A and 11B are diagrams illustrating the structure of an ink layer on the recording medium P. FIG. 11A is a diagram showing the ink layer structure including surface layers and an internal layer on the recording medium, formed during image formation using color inks, a white ink, and two types of reaction liquids according to the present embodiment. FIG. 11A shows an ink-free region 1100 where no ink is applied, a non-laminated region 1101 composed only of a color ink layer CL1, a non-laminated region 1103 composed only of a white ink layer WL1, and a laminated region 1102 where a color ink layer CL2 is laminated on a white ink layer WL2. FIG. 11B is a table summarizing the relationship between symbols indicating the regions in FIG. 11A and the presence or absence of an ink layer.

In the present embodiment, an image is recorded with improved surface smoothness by using the weak-reactivity reaction liquid B for the color ink layer CL1 in the non-laminated region 1101 and the white ink layer WL1 in the non-laminated region 1103, thereby reducing the visual inconsistency caused by the difference in surface properties at the boundary with the ink-free region 1100. In other words, even for undercoat layers in contact with the recording medium P, if the entire layers are exposed, the undercoat layers (here, the color ink layer CL1 and the white ink layer WL1) are treated as surface layers, and the low-reactivity reaction liquid B is used. Thus, the undercoat layers that are entirely exposed (which are also surface layers) have high surface smoothness, improving affinity with the recording medium P.

In the present embodiment, in the laminated region 1102, the strong-reactivity reaction liquid A is used for the internal white ink layer WL2 to strongly aggregate the ink. This is to prevent the internal white ink layer WL2 and the surface color ink layer CL2 from mixing when the color ink layer CL2 is recorded on top of the white ink layer WL2, which is the lower layer. On the other hand, in the present embodiment, recording is performed using the weak-reactivity reaction liquid B for the color ink layer CL2, which is a surface layer, to improve surface smoothness. As a result, although the surface smoothness of the internal white ink layer may decrease, the surface smoothness as seen from the viewer's perspective can be improved. Therefore, in the present embodiment, it is possible to suppress visual inconsistency during observation and enhance affinity with the recording medium having high surface smoothness.

The following describes details of the data processing related to image processing and recording data generation, as one embodiment for realizing the above-described layer structure.

### <Configuration of Control System of Recording Apparatus>

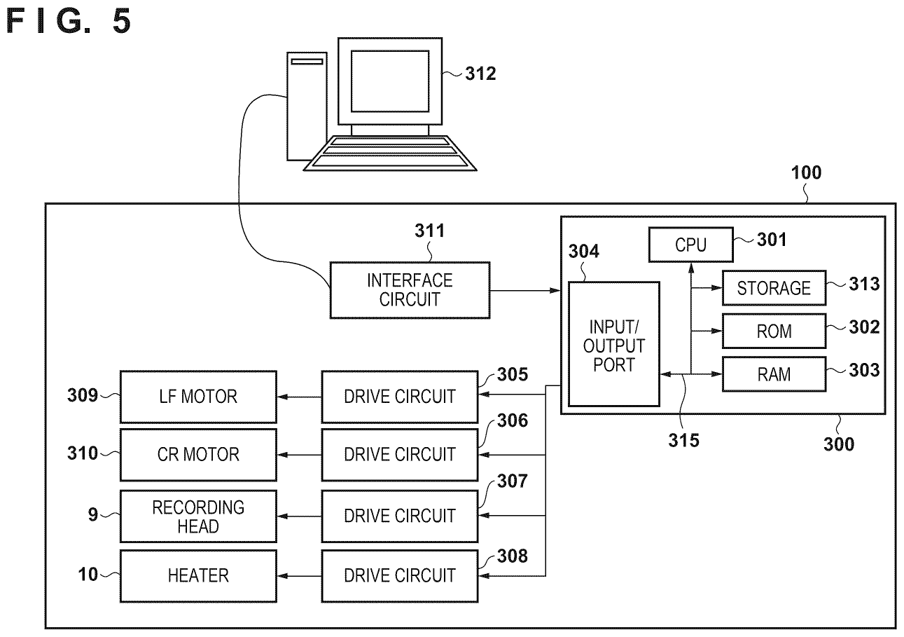

FIG. 5 is a block diagram showing a schematic configuration of the control system of a recording apparatus 100 according to the present embodiment. The recording apparatus 100 includes a main control unit 300, an interface circuit 311, a drive circuit 305, a drive circuit 306, a drive circuit 307, a drive circuit 308, an LF motor 309, a CR motor 310, the recording head 9, and the heater 10.

The main control unit 300 includes a CPU 301, a ROM 302, a RAM 303, an input/output port 304, a storage 313, and a bus 315. The CPU 301, the ROM 302, the RAM 303, the input/output port 304, and the storage 313 are connected to each other via the bus 315 so that they can transmit and receive data to and from each other.

The CPU 301 stands for Central Processing Unit and is a so-called processor. The CPU 301 performs processing operations such as calculation, selection, determination, and control, as well as recording operations to record data such as images on a recording medium. The recording apparatus 100 may include another processor such as an MPU (Micro Processing Unit), a GPU (Graphics Processing Unit), or a QPU (Quantum Processing Unit) in place of or in addition to the CPU 301. The CPU 301 reads programs stored in the ROM 302, the storage 313, or the like, loads them into the RAM 303, and realizes various functions and performs various types of processing. For example, the CPU 301 reads a program for image recording processing and records an image on a recording medium. A portion or all of the functions realized by the CPU 301 may be realized by one or more circuits, such as an ASIC (Application Specific Integrated Circuit) or a PLD (Programmable Logic Device) including an FPGA (Field Programmable Gate Array). The CPU 301 is an example of an acquisition unit, a generation unit, and a pass division unit means.

The ROM 302 stands for Read Only Memory and is a non-volatile storage apparatus. The ROM 302 stores control programs and the like to be executed by the CPU 301.

The RAM 303 stands for Random Access Memory and is a volatile storage apparatus capable of high-speed reading and writing. The RAM 303 functions as a buffer for recording data and as a work area for the CPU 301 when executing a program, for example.

The storage 313 is a large-capacity non-volatile storage apparatus. The storage 313 is, for example, an HDD (Hard Disk Drive), SSD (Solid State Drive), or the like. The storage 313 stores mask patterns, image data, and the like, which will be described later. The storage 313 stores an OS (Operating System) and a program for image recording processing to record images onto a recording medium, for example.

The drive circuits 305, 306, 307, and 308 are connected to the input/output port 304 to drive the LF motor 309, which functions as a conveyance motor. the CR motor 310, which functions as a carriage motor, the recording head 9, and the heater 10. An actuator or the like in a cutting unit may also be connected to the input/output port 304.

The main control unit 300 is connected to a computer 312, which is a host apparatus, via the interface circuit 311. The computer 312 is, for example, a personal computer. In the present embodiment, a personal computer is adopted as the host apparatus, but the host apparatus is not limited to this. In the present embodiment, any computer such as a smartphone may be adopted as the host apparatus.

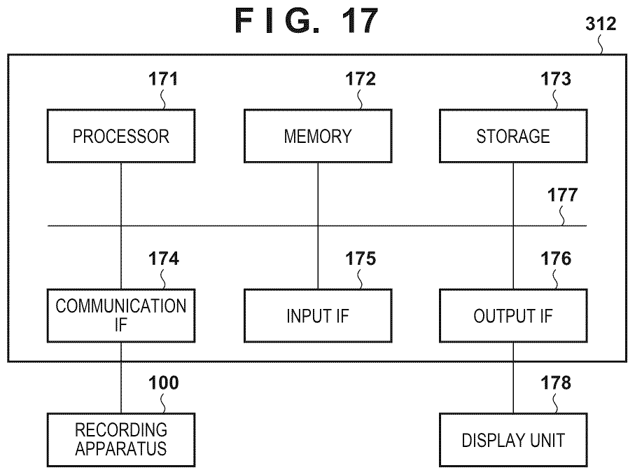

FIG. 17 is a block diagram illustrating the hardware configuration of the computer 312. As shown in FIG. 17, the computer 312 includes a processor 171, a memory 172, a storage 173, a communication IF 174, an input IF 175, an output IF 176, and a bus 177. The processor 171, the memory 172, the storage 173, the communication IF 174, the input IF 175, and the output IF 176 are connected to each other via the bus 177 so that they can transmit and receive information to and from each other.

The processor 171 includes one or more processors such as a CPU, a GPU, an MPU, or a QPU. The processor 171 reads programs and drivers stored in the storage 173, loads them into the memory 172, and realizes various functions and performs processing.

The memory 172 may be a high-speed readable and writable storage apparatus such as a RAM. For example, the memory 172 functions as a work area for the processor 171 when executing a program.

The storage 173 may be a non-volatile storage apparatus such as an HDD or an SSD. The storage 173 stores programs such as image recording processing programs, data such as image data processed through execution of the programs, and parameters and the like necessary for executing the programs.

The communication IF 174 is an interface connected to a network or the like. The communication IF 174 realizes communication with the recording apparatus 100. The communication IF 174 outputs data received from the outside to the processor 171 and transmits data to the recording apparatus 100 or the like based on instructions from the processor 171.

The input IF 175 receives input from a user or the like. For example, the input IF 175 receives user input from a keyboard, a mouse, a touch panel, or the like. The input IF 175 outputs the received input to the processor 171.

The output IF 176 outputs data to an external apparatus. For example, the output IF 176 outputs image data received from the processor 171 to a display unit 178 such as a liquid crystal display to display an image.

### <Image Data Conversion Processing>

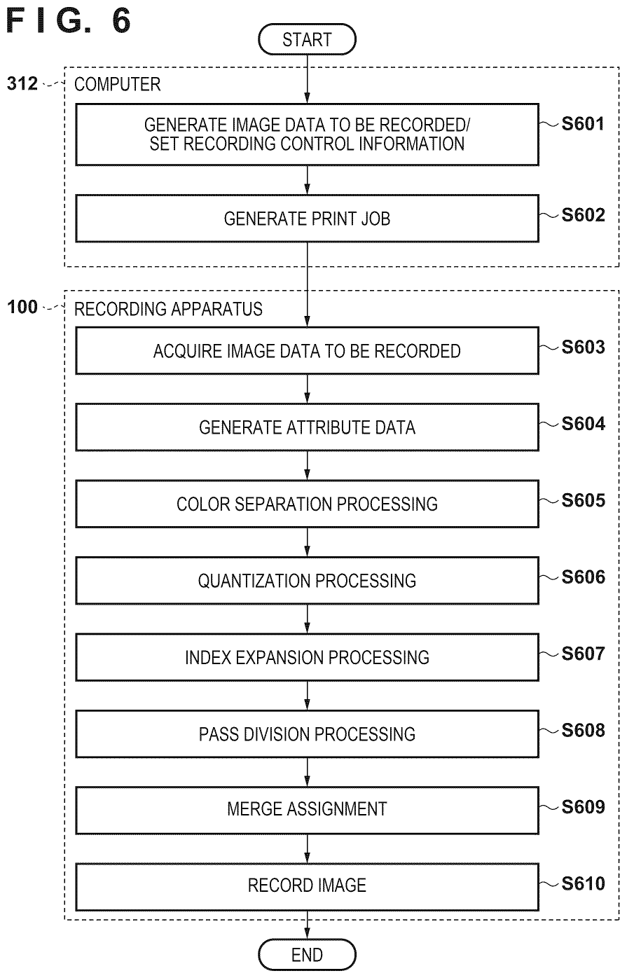

FIG. 6 is a flowchart illustrating the flow of image recording processing performed to convert image data to record an image. This process may be referred to as image conversion processing, image data conversion processing, or image processing. The image processing according to the present embodiment is performed to record an image with a multilayer structure in which color ink is laminated on white ink. This recording mode is referred to as the white undercoat mode.

The image recording processing in the recording system according to the present embodiment is performed by the computer 312 and the recording apparatus 100. This image recording processing is performed to create data indicating the formation position of ink dots for each recording scan from the input image data, and record an image. This image recording processing is constituted by a series of processing steps. Each processing step included in this series of processing steps is carried out by either the computer 312 or the recording apparatus 100 functioning as an image processing apparatus. Note that a portion of the series of processing steps may be carried out in a shared manner.

### <Print Job Generation>

The computer 312 stores an application program (not shown) and a printer driver (not shown) corresponding to the recording apparatus 100 in the storage 173. The processor 171 reads and executes the program and the printer driver to perform the processing in steps S601 and S602.

In step S601, the processor 171 performs processing to generate image data to be recorded, and to set recording control information that controls recording. For example, the processor 171 reads and executes the application program to display a GUI screen on the display unit 178 connected to the output IF 176. Based on the information specified by the user via the GUI screen, the processor 171 generates image data to be recorded and transmitted to the printer driver and sets recording control information that controls recording. In FIG. 6, the processing performed to generate image data to be recorded and the processing performed to set recording control information are collectively described as the processing in step S601, but these two processing steps may be carried out separately. The processor 171 passes the image data to be recorded generated by the application and the set recording control information to the printer driver module.

In step S602, the processor 171 performs print job generation processing using the printer driver module. For example, the processor 171 generates a print job including a series of print command data based on the image data to be recorded generated by the application and the set recording control information. The processor 171 transmits the print job to the recording apparatus 100 via the communication IF 174 and the interface circuit 311.

The CPU 301 of the main control unit 300 in the recording apparatus 100 receives the print job including the series of print command data and temporarily stores the received print job in the RAM 303, which is a work memory. The print command data includes, in addition to the image data, information indicating the size of the image data, the recording mode for recording it, and so on. The main control unit 300 performs the image processing described below based on the results of analyzing these pieces of information.

The CPU 301 reads programs stored in the storage 313 of the main control unit 300 in the recording apparatus 100 and performs the image processing steps from step S603.

### <Image Analysis>

In step S603 shown in FIG. 6, the CPU 301 acquires image data to be recorded and stores it in the RAM 303, the storage 313, or the like included in the recording apparatus 100. Here, the image data to be recorded may include color development image data indicating content such as a photo, a poster, or a drawing to be drawn, and undercoat image data used to create an undercoat in the background. Specifically, the image data to be recorded may be image data in a format in which undercoat image data of a grayscale W image for white is added to color development image data in a general format of an RGB image or CMYK image (e.g., RGB image+W image or CMYK image+W image).

Here, each RGB image signal value representing the color development image data may be an 8-bit value. A signal value of 0 indicates black (low brightness), and 255 indicates white (high brightness). In other words, the signal values (R, G, B)=(255, 255, 255) mean “white” in the color development image data. The W image representing the undercoat image indicates the concealment rate. The W image signal values may be 8-bit values. A signal value of 0 indicates “transparent” (zero concealment rate), and 255 indicates “white” (maximum concealment rate).

The present embodiment describes the case of RGB+W raster image data. However, the image data is not limited to RGB+W raster image data. For example, image data may be obtained only in a general format, which is RGB or CMYK color development image data, and undercoat image data may be generated by treating signal values (R, G, B)=(255, 255, 255) or (C, M, Y, K)=(0, 0, 0, 0), which indicate a white region, as an undercoat region.

In step S604, the CPU 301 generates attribute data indicating either a surface layer or an internal layer for the input image data to be recorded. As a method for generating attribute data, the CPU 301 may reference both the signal values of the RGB data, which is the color development image, and the signal values of the W image data, which is the undercoat image at the same coordinates, and generate binary attribute data indicating a surface layer or an internal layer for both the RGB data of the color development image and the white ink data of the undercoat image, depending on whether the signal values meet conditions.

A method by which the CPU 301 generates attribute data will be specifically described using the schematic diagram in FIG. 11A and the table in FIG. 11B. When the recording mode is the white undercoat mode, the CPU 301 generates attribute data of RGB color development images for the color ink layers CL1 and CL2 as surface layers, as shown in the non-laminated region 1101 and the laminated region 1102. Regarding the white ink layer WL2 of the undercoat W image, the CPU 301 basically generates attribute data for an internal layer as shown in the laminated region 1102. However, when the RGB image for the surface layer is (R, G, B)=(255, 255, 255), that is, in the case of the non-laminated region 1103 where there is no color ink and no color ink layer, the CPU 301 generates attribute data for the white ink layer WL1 of the W image as a surface layer. The internal layer in the laminated region 1102 shown in FIG. 11A is an example of an undercoat layer in contact with the recording medium P.

### <Color Separation Processing>

In step S605, the CPU 301 performs color separation processing to generate color separation data. Specifically, the CPU 301 converts the input image data to be recorded into image data constituted by color signals for the colorant inks to be used by the recording apparatus 100. The CPU 301 generates application amount data (W_1L) for the white ink, application amount data (RCTA_1L) for the reaction liquid A, and application amount data (RCTB_1L) for the reaction liquid B, from the W image data of the image data to be recorded, which is undercoat image data for preceding ejection (the layer to be printed first). The CPU 301 generates application amount data (C_2L, M_2L, Y_2L, K_2L) for the color inks, application amount data (RCTA_2L) for the reaction liquid A, and application amount data (RCTB_2L) for the reaction liquid B, from the RGB image data included in the image data to be recorded, which is color development image data for subsequent ejection (the layer to be printed second). In other words, in the color separation processing, the CPU 301 generates color separation data in which the application amounts of the inks and the reaction liquids are set for each layer. Furthermore, as shown in FIG. 11A, the CPU 301 may switch the combination and application amounts of the color inks, the white ink, the reaction liquid A, and the reaction liquid B for each layer and each region.

The method for converting signal values into color signals may be a known method, such as the CPU 301 referring to a lookup table (LUT) stored in advance in the ROM 302 or the like. Although the CPU 301 mainly uses the white ink for recording the undercoat image, it may perform color separation processing using other color inks together for the purpose of white color adjustment. When performing color separation processing, the balance between the application amounts of the colorant inks and the application amounts of the reaction liquids is important. By appropriately increasing the application amounts of the reaction liquids in accordance with the increased application amounts of the colorant inks, it is possible to promote an increase in the viscosity of the ink liquids and suppress beading during image formation. However, if the application amounts of the reaction liquids are too small relative to the application amounts of the colorant inks, the colorants cannot sufficiently aggregate, resulting in an insufficient increase in viscosity and leading to beading. Conversely, if the application amounts of the reaction liquids are too large relative to the application amounts of the colorant inks, the moisture content of the reaction liquids becomes excessive, resulting in no increase in viscosity and similarly leading to beading. Therefore, in order to achieve favorable image formation, it is necessary to perform color separation processing for both the color development image data and the undercoat image data with an appropriate balance of application amounts. This will be described in detail below.

First, the data of the W image, which is the undercoat image for preceding ejection (the first layer), will be described. Based on the region attributes indicating the internal layer or the surface layer generated in step S604, the CPU 301 converts the data of the W image, which is the undercoat image, into the application amount data (W_1L) for the white ink, the application amount data (RCTA_1L) for the reaction liquid A for the first layer, and the application amount data (RCTB_1L) for the reaction liquid B for the first layer, for the recording apparatus. The CPU 301 expresses each of the application amount data W_1L, RCTA_1L, and RCTB_1L as 8-bit data. In the 8-bit values, i.e., values ranging from 0 to 255, 0 indicates an application amount of 0%, and 255 indicates an application amount of 100%. Intermediate values (1 to 254) correspond to application amounts that each increase proportionally with the value.

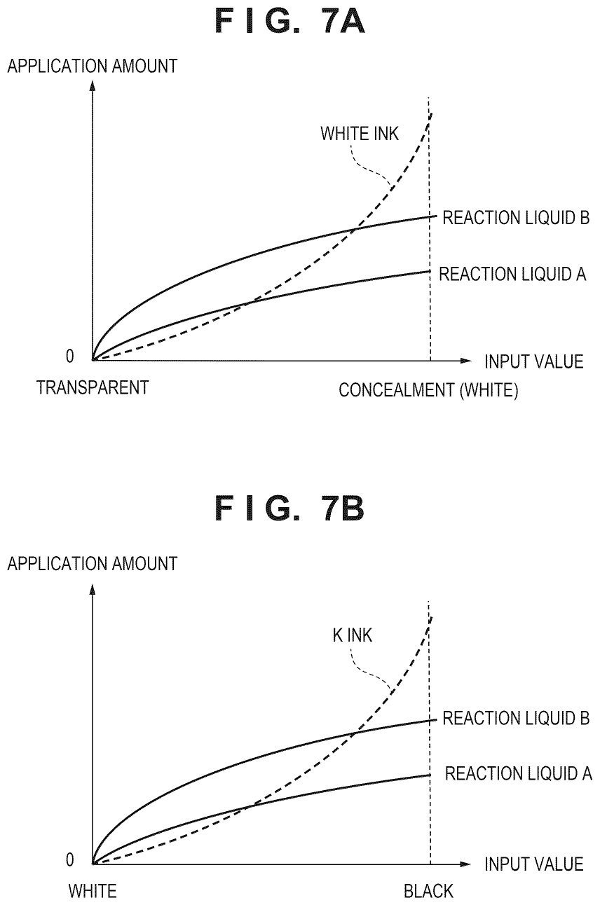

FIGS. 7A and 7B are diagrams illustrating calculation processing performed on image data, using a one-dimensional lookup table (LUT). FIG. 7A is a diagram illustrating calculation processing performed on data of a W image, which is an undercoat image, using a one-dimensional lookup table (LUT). The horizontal axis in FIG. 7A indicates the concealment rate. The vertical axis indicates the application amounts of the inks and the reaction liquids. As shown in FIG. 7A, the CPU 301 references the lookup table to generate application amount data (W_1L) for the white ink, the application amount data (RCTA_1L) for the reaction liquid A, and application amount data (RCTB_1L) for the reaction liquid B, from the data of the undercoat W image. The larger the value of the undercoat W image, the higher the concealment rate, and the CPU 301 increases the application amount of the white ink as the concealment rate increases. The CPU 301 increases the application amounts of the reaction liquids in accordance with the increased application amount of the white ink.

Here, for the pixels of the undercoat W image whose attribute data indicates an internal layer, the CPU 301 sets the signal value shown in the graph to RCTA_1L and sets zero to the value of RCTB_1L. On the other hand, for the pixels of the undercoat W image whose attribute data indicates a surface layer, the CPU 301 sets zero to the value of RCTA_1L and converts the value of RCTB_1L to the value shown in the graph. Thus, the CPU 301 can perform control to apply the reaction liquid A if the undercoat W image is an internal layer and apply the reaction liquid B if it is a surface layer.

Next, the data of the RGB image, which is a color development image for subsequent ejection (the second layer) will be described. Based on the attribute data indicating either an internal layer or a surface layer generated in step S604, the CPU 301 converts the data of the RGB image, which is a color development image, into application amount data (C_2L, M_2L, Y_2L, K_2L) for the color inks, application amount data (RCTA_2L) for the reaction liquid A of the second layer, and application amount data (RCTB_2L) for the reaction liquid B of the second layer, for the recording apparatus 100. The CPU 301 expresses each piece of application amount data C_2L, M_2L, Y_2L, K_2L, RCTA_2L, and RCTB_2L as 8-bit data. In the values ranging from 0 to 255, 0 indicates an application amount of 0%, and 255 indicates an application amount of 100%. Intermediate values (1 to 254) indicate application amounts that each increase proportionally with the value.

When the RGB image data represents an image in a color space coordinate such as sRGB for monitor display colors, the CPU 301 converts the sRGB color coordinates (R, G, B) into ink color application amount data (C_2L, M_2L, Y_2L, K_2L) for the recording apparatus 100. The CPU 301 may convert the color coordinates to application amount data using a known technique such as matrix calculation processing or processing using a three-dimensional lookup table (LUT). Since the recording apparatus 100 according to the present embodiment uses black (K), cyan (C), magenta (M), and yellow (Y) inks, the CPU 301 converts the RGB signal image data into multi-valued image data constituted by 8-bit color signals for C_2L, M_2L, Y_2L, and K_2L. The converted image data may be application amount data for the color inks. The value of the color signal of each color ink corresponds to the application amount of the color ink. The CPU 301 expresses the application amount for each of the CMYK colors as 8-bit data. In the 8-bit values, i.e., values ranging from 0 to 255, 0 indicates a color ink application amount of 0%, and 255 indicates a color ink application amount of 100%. Intermediate values (1 to 254) correspond to color ink application amounts that each increase proportionally with the value.

The number of color inks is not limited to the four colors K, C, M, and Y. When using other inks such as light cyan (Lc), light magenta (Lm), and gray (Gy) with lower density to improve the image quality of the recorded image, the CPU 301 generates color signals corresponding to them.

FIG. 7B is a diagram illustrating calculation processing performed on data of an RGB image, which is a color development image, using a one-dimensional lookup table (LUT). The relationship between the data of the RGB image data, which is a color development image, and the application amount data (C_2L, M_2L, Y_2L, K_2L) for the color inks, the application amount data (RCTA_2L) for the reaction liquid A of the second layer, and the application amount data (RCTB_2L) for the reaction liquid B of the second layer will be described using FIG. 7B. The horizontal axis in FIG. 7B indicates the input value in the color separation processing in step S605. This horizontal axis indicates the achromatic gradation (R=G=B) from white (R=G=B=255) to black (R=G=B=0). The vertical axis indicates the application amounts of the inks and the reaction liquids, which are the output signal values in the color separation processing in step S605. As the density of the input image increases, the CPU 301 increases the application amount of the K ink, and as the application amount of the K ink increases, the CPU 301 increases the application amounts of the reaction liquids. In this way, the CPU 301 appropriately increases the application amounts of the reaction liquids in accordance with the increase in the application amount of the K ink, thereby increasing the viscosities of the ink liquids to suppress bleeding. Here, the case of achromatic gradation using only K ink is described, but the same applies to chromatic gradation or cases of composite colors using multiple inks. As the total application amount of the C ink, the M ink, the Y ink, and the K ink increases, the CPU 301 increases the application amounts of the reaction liquids, thereby increasing the viscosities of the ink liquids to suppress bleeding. The CPU 301 may realize these controls using a known technique such as the aforementioned matrix calculation processing or processing using a three-dimensional lookup table (LUT).

Here, for the pixels of the RGB color development image whose attribute data indicates an internal layer, the CPU 301 sets the signal value shown in the graph to RCTA_2L and sets zero to RCTB_2L. For the pixels of the RGB color development image whose attribute data indicates a surface layer, the CPU 301 sets the value of RCTA_2L to zero and sets the value of RCTB_2L to the value shown in the graph. Thus, the CPU 301 can perform control to apply the reaction liquid A if the data indicates an internal layer and apply the reaction liquid B if the data indicates a surface layer. In other words, the CPU 301 generates data on the application amounts of the reaction liquid A and the reaction liquid B for each layer. Furthermore, the CPU 301 may generate data on the application amounts of the reaction liquid A and the reaction liquid B for each of the non-laminated region 1101, the laminated region 1102, and the non-laminated region 1103, even within the same layer.

### <Halftone Processing>

In step S606, the CPU 301 performs quantization processing. Specifically, in the quantization processing, the CPU 301 converts the multi-valued data on the colorant inks and the multi-valued data on the reaction liquids after color separation processing into quantized data of a few bits. For example, when quantizing to 4 values, the CPU 301 converts gradation data into 2-bit data of levels 0 to 3. Known methods for quantization processing include the error diffusion method and the dither method, and any method may be adopted.

In step S607, the CPU 301 performs index expansion processing based on the quantized data on the colorant inks and the reaction liquids. Specifically, the CPU 301 selects one dot arrangement pattern from a plurality of dot arrangement patterns that define the number of dots to be recorded in individual pixels, in association with the levels acquired in step S606. At this time, the CPU 301 may use a dot arrangement pattern in which the number of dots to be recorded in regions corresponding to individual pixels are varied based on the level values. The CPU 301 sets the number of dots for the color inks among the colorant inks to 0, 1, 2, or 3. For the purpose of concealment, the CPU 301 sets the number of dots for the white ink to 0, 2, 4, or 6. By setting the values in this way, the CPU 301 can record more white ink on the recording medium, enabling recording with higher concealability.

### <Multi-Pass Recording Method>

In step S608, the CPU 301 performs pass division processing. Specifically, in the pass division processing, the CPU 301 performs processing in which pass masks are used to assign the dot data, acquired by index expansion of the colorant ink data and reaction liquid data, to the ejection ports that perform the recording. In other words, in the pass division processing, the CPU 301 sets the ejection ports that eject the inks and the reaction liquids. In the present embodiment, the pieces of dot assignment data (W_1L, RCTA_1L, RCTB_1L, C_2L, M_2L, Y_2L, K_2L, RCTA_2L, RCTB_2L) for the inks described so far are recorded in predetermined regions of the recording medium through a plurality of scans. This is referred to as the multi-pass recording method. The CPU 301 generates pieces of recording data respectively corresponding to the scans by performing a logical AND operation between pieces of binary dot assignment data for the recording materials (W_1L, RCTA_1L, RCTB_1L, C_2L, M_2L, Y_2L, K_2L, RCTA_2L, and RCTB_2L), and the pass masks respectively corresponding to the scans.

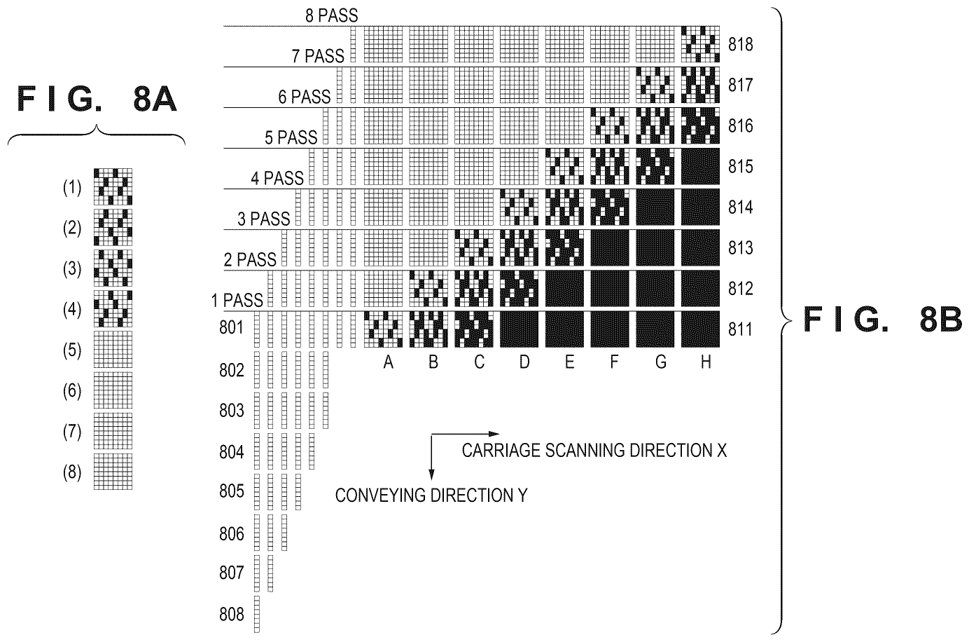

FIGS. 8A and 8B are diagrams illustrating the pass masks corresponding to the scans for performing pass division processing on the pieces of dot assignment data (W_1L, RCTA_1L, and RCTB_1L) for preceding ejection (first layer, undercoat layer). The squares in the X direction indicate the coordinates of the regions corresponding to the pixels to be recorded. The squares in the Y direction correspond to the 1280 ejection ports of the ejection port array. Each pass mask is formed by arranging recording-permitted pixels, which allow droplet ejection, and non-recording-permitted pixels, which do not allow droplet ejection. The black squares represent pixels where ejection is performed (value 1), and the white squares represent pixels where no ejection is performed (value 0). In FIGS. 8A and 8B, for the sake of simplicity, the ejection ports are represented using 64 squares, and recording in an 8-pass scan is illustrated as an example.

FIG. 8A is a diagram illustrating the pass masks respectively corresponding to the passes in 8-pass recording. In the first recording scan, the pass mask (1) in FIG. 8A is applied, and in the second recording scan, the pass mask (2) in FIG. 8A is subsequently applied. Accordingly, the pass masks (1) to (8) shown in FIG. 8A are sequentially applied in the eight recording scans. Here, since the pass masks (5) to (8) in FIG. 8A are all white squares, no recording is performed with this ejection port array in the fifth to eighth recording scans.

FIG. 8B is a schematic diagram showing the process of performing recording scans using the pass masks shown in FIG. 8A. The ejection port array is divided into eight recording groups, 801, 802, 803, 804, 805, 806, 807, and 808, in the Y-axis direction. In the following, the recording medium P is divided into regions 811, 812, 813, 814, 815, 816, and 817 for description. The states of image formation at the respective ends of the recording scans are indicated by A to H in the lower section. In the first scan, ink is ejected from the recording group 801 into the region 811 of the recording medium P according to the recording data indicated by (1) in FIG. 8A. The image formation state on the recording medium P when the first recording scan is complete is shown in black as the state A in FIG. 8B.

Next, the recording medium P is conveyed relative to the recording head 9 in the Y-axis direction by a distance of eight ejection ports (i.e., 64 ejection ports divided by 8), after which the second recording scan is performed. In the second recording scan, ink is ejected from the recording group 802 into the region 811 of the recording medium P according to the recording data indicated by (2) in FIG. 8A, and from the recording group 801 into the region 812 according to the recording data indicated by (1) in FIG. 8A. The image formation state on the recording medium P when this second recording scan is complete is shown in black as the state B in FIG. 8B.

Thereafter, the recording scans by the recording head 9 and the relative conveyance of the recording medium P are alternately repeated. As a result, after the third recording scan, the image formation state on the recording medium P is the state C in FIG. 8B, and after the fourth recording scan, the image formation state on the recording medium P is the state D in FIG. 8B. In other words, after the fourth recording scan, all ink ejections required for recording in the region 811 of the recording medium P are complete, as indicated by the state D in FIG. 8B. Thereafter, the image formation states on the recording medium P when the fifth to eighth recording scans are complete are the states E to H in FIG. 8B.

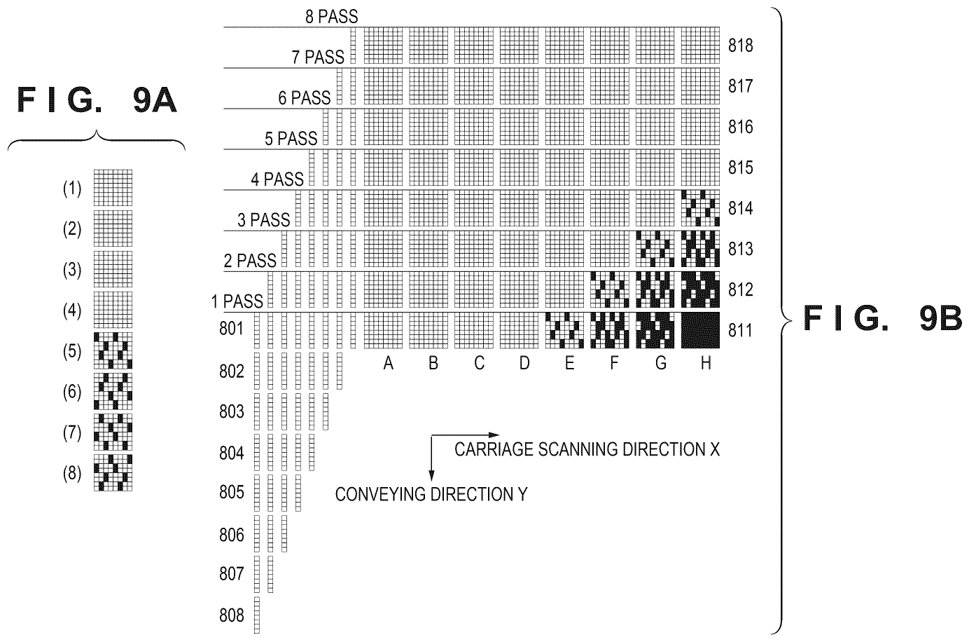

FIGS. 9A and 9B are diagrams illustrating the pass masks corresponding to the scans for performing pass division processing on the pieces of dot assignment data (C_2L, M_2L, Y_2L, K_2L, RCTA_2L, and RCTB_2L) for subsequent ejection (second layer, surface layer).

FIG. 9A is a diagram illustrating the pass masks respectively corresponding to the passes in 8-pass recording. As shown in FIG. 9A, no recording is performed with this ejection port array in the first to fourth recording scans. On the other hand, in the fifth to eighth recording scans, all the recording-permitted pixels in the unit region are set. In other words, in the first recording scan, the pass mask (1) shown in FIG. 9A is applied, and in the second recording scan, the pass mask (2) shown in FIG. 9A is subsequently applied. Accordingly, the pass masks (1) to (8) shown in FIG. 9A are sequentially applied in the eight recording scans.

FIG. 9B is a schematic diagram showing the process of performing recording scans using the pass masks shown in FIG. 9A. Nothing is recorded in the first to fourth recording scans, and in the fifth to eighth recording scans, the ejection of all the inks to be recorded with this nozzle array are complete in the region 811 in the state H of the recording medium P.

As described above, laminated printing is enabled by setting the pass masks (1) to (8) in FIG. 8A for the preceding ejection (first layer) and the pass masks (1) to (8) in FIG. 9A for the subsequent ejection (second layer).

In step S609, the CPU 301 merges the pieces of data to be assigned. Specifically, the CPU 301 generates the pieces of data to be assigned to the ejection port arrays 22K, 22C, 22M, 22Y, 22W, 22RCTA, and 22RCTB from the data after pass division processing performed using the pass masks. More specifically, the CPU 301 merges the dot assignment data for the preceding ejection (first layer) and the dot assignment data for the subsequent ejection (second layer), which are to be recorded using the same ejection port array, by performing a logical OR operation.

$$C = C\_ 2 L , M = M\_ 2 L , Y = Y\_ 2 L , K = K\_ 2 L$$

$$W = W\_ 1 L$$

$$RCTA = RCTA\_ 1 L + RCTA\_ 2 L$$

$$RCTB = RCTB\_ 1 L + RCTB\_ 2 L$$

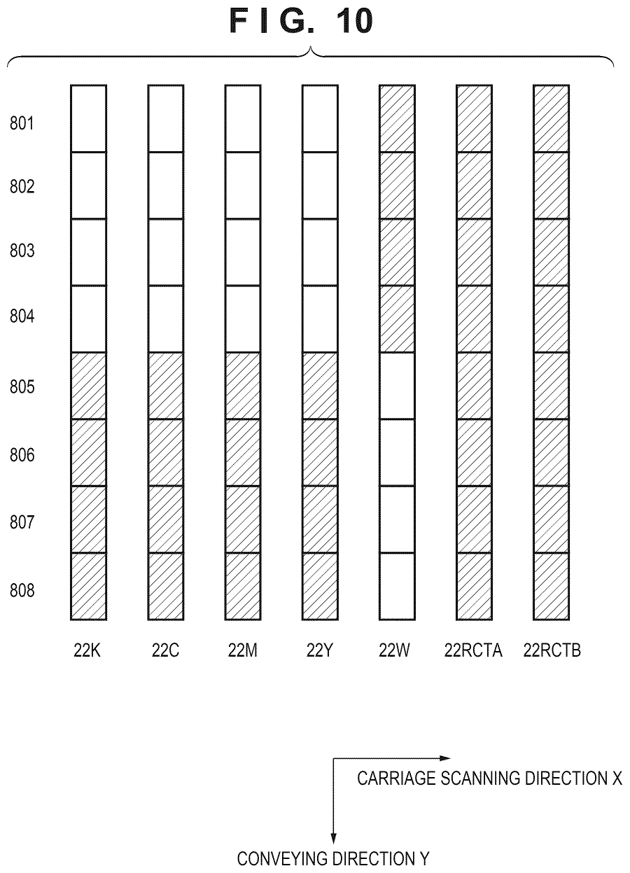

FIG. 10 is a schematic diagram illustrating the ejection ports used for recording among the ejection port arrays provided in the recording head 9. In FIG. 10, the regions with ejection ports that perform recording at least once are indicated by hatching. FIG. 10 shows the case of recording and printing performed in 8-pass scanning. The white ink (W) for recording the first layer is recorded using the pass masks with the characteristics shown in FIG. 8A. The colorant inks (C, M, Y, and K) for recording the second layer is recorded using the pass masks with the characteristics shown in FIG. 9A. Therefore, the regions are divided into upper and lower regions.

On the other hand, regarding the ejection ports for recording the reaction liquid A (RCTA) and the reaction liquid B (RCTB), the dot assignment data for the preceding ejection (first layer) and the dot assignment data for the subsequent ejection (second layer) are merged, and the upper and lower regions are used for each of the first and second layers.

Finally, in step S610, the CPU 301 records the image on the recording medium based on the pass-divided data. With this, the CPU 301 completes the processing.

### Effects of the Present Embodiment

In the present embodiment, color separation data is generated for each layer, including the reaction liquid data for the undercoat image and the reaction liquid data for the color development image that forms the surface layer. Thus, in the present embodiment, images can be appropriately recorded in accordance with the viewing position or the surface of the recording medium.

Specifically, the present embodiment shows a printing method in which, during laminated printing, the strong-reactivity reaction liquid A is used for the ink that forms the internal layer, which also serves as the undercoat layer, to strongly aggregate the layer, while the weak-reactivity reaction liquid B is used for the ink that forms the surface layer to produce a smoother finish. Thus, in the present embodiment, a robust layer structure can be formed through strong aggregation in the undercoat layer while concealing the recording medium, and high surface smoothness can be achieved in the surface layer due to its high affinity with the surface of the recording medium. As a result, the present embodiment can achieve good printing results for various applications such as advertisements and signboards.

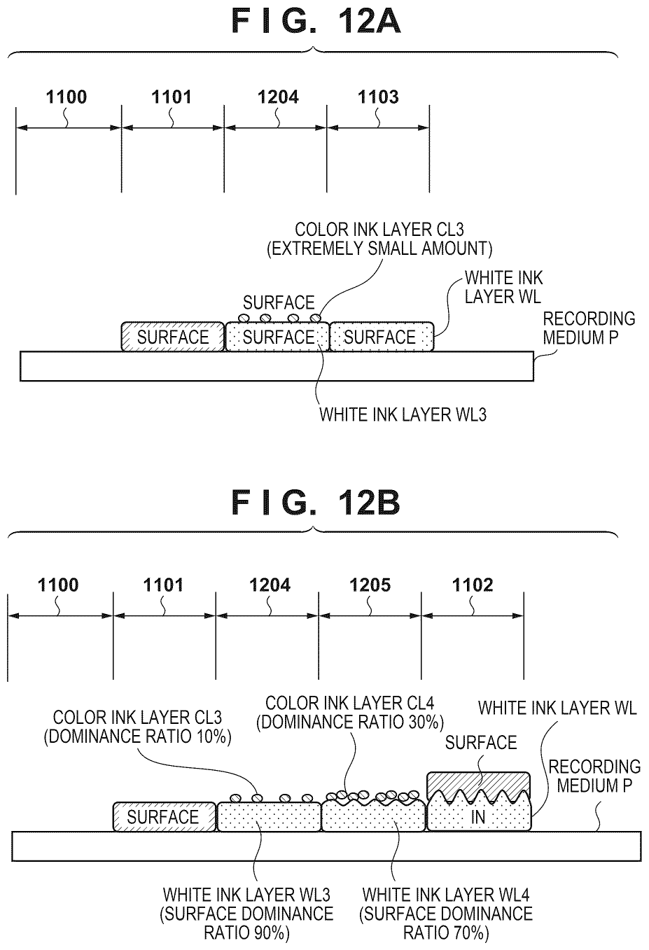

Note that the first embodiment describes a method for determining, when generating attribute data that includes an attribute data indicating whether each portion corresponds to a surface layer or an internal layer in step S604, whether the amounts of color inks for the subsequent ejection are zero, using the table shown in FIG. 11B. However, the method of generating attribute data is not limited to this. Another example of the method for generating attribute data will be described with reference to FIGS. 12A and 12B, 13, and 14A and 14B.

FIGS. 12A and 12B are diagrams illustrating a case where the undercoat layer is exposed. The undercoat layer becomes exposed on the surface when the amounts of the color inks for the subsequent ejection are small. FIG. 12A is a diagram illustrating a method for setting attribute data when the amounts of the color inks for the subsequent ejection ink are small. Here, as shown in the region 1204 in FIG. 12A, when a white ink layer WL3, which is an undercoat layer, is exposed from a color ink layer CL3, which is a surface layer, it is assumed that the undercoat white ink layer WL3 is partially exposed from the surface layer. As shown in FIG. 12A, if the amounts of the color inks for the subsequent ejection are very small, the white ink layer WL3 under the color ink layer CL3 is dominant on the surface. In such a case, the CPU 301 can further improve image quality by setting the color ink layer CL3 for the subsequent ejection as a surface layer and also setting the white ink layer WL3 for the preceding ejection as a surface layer. In this case, the CPU 301 may generate color separation data to eject the reaction liquid B to the white ink layer WL3 set as the surface layer, thereby increasing the surface smoothness of the white ink layer WL3, which serves as both an undercoat layer and a surface layer. Thus, the present embodiment can improve affinity with the recording medium P even in the case where the undercoat layer of the image is exposed.

FIG. 12B is a diagram illustrating the setting of attribute data in the case where the attribute data is set using multiple values. Although the first embodiment describes control performed to set two-value attribute data, indicating a surface layer or an internal layer, the CPU 301 may set the attribute data using three or more values. Here, it is assumed that the rate at which the undercoat white ink layer WL is partially exposed from the surface color ink layer CL varies by region. As shown in FIG. 12B, the CPU 301 may set attribute data based on the surface dominance ratio of the white ink layer for the preceding ejection. The surface dominance ratio indicates the proportion of the white ink exposed on the surface. Here, the smaller the amount of the color ink for subsequent ejection, the higher the surface dominance ratio of the white ink. The CPU 301 determines the surface dominance ratio of the white ink to be 100% when the amount of the color ink is zero, and 0% when the amount exceeds a threshold value. The CPU 301 may control the distribution of the reaction liquid A and the reaction liquid B based on the surface dominance ratio. For example, in a region 1205 where the surface dominance ratio of a color ink layer CL4 is 30% and the surface dominance ratio of a white ink layer WL4 is 70%, the CPU 301 may apply settings to use a mixture in which 30% of the total amount is the reaction liquid A for the internal layer and 70% is the reaction liquid B for the surface layer. Similarly, in the region 1204 where the surface dominance ratio of the color ink layer CL3 is 10% and the surface dominance ratio of the white ink layer WL3 is 90%, the CPU 301 may apply settings to use a mixture in which 10% of the total amount is the reaction liquid A for the internal layer and 90% is the reaction liquid B for the surface layer. Since the CPU 301 can connect gradations more smoothly than in the case of determining and switching based on binary attribute data, it can further improve gradation characteristics.

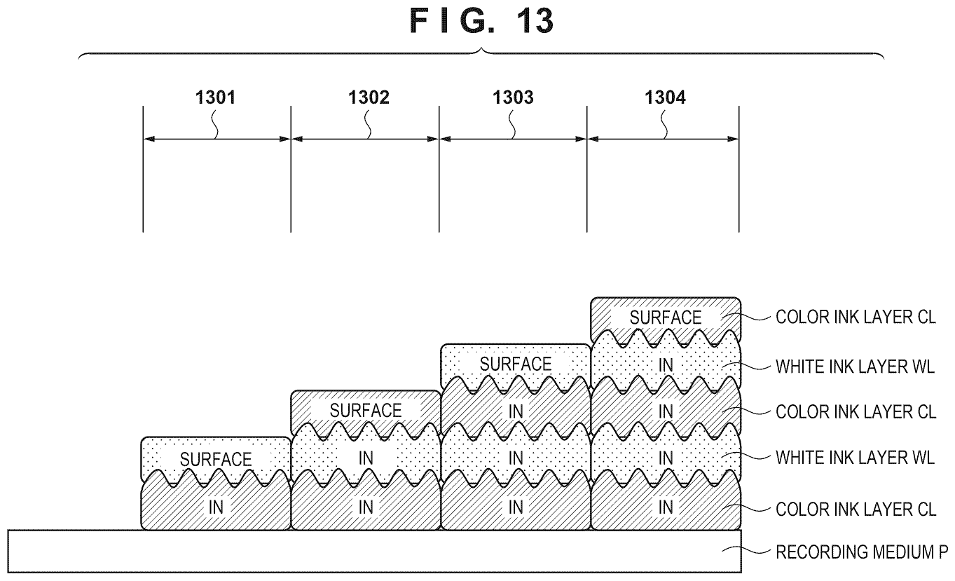

FIG. 13 is a diagram illustrating a case with three or more ink layers. Although the first embodiment describes the case of a two-layer structure shown in a region 1301, the type of laminated structure is not limited to this configuration. As shown in FIG. 13, the ink layer structure may also be a three-layer structure as shown in a region 1302 with a white ink layer WL as an intermediate layer and color ink layers CL on the top and bottom. The ink layer structure may also be a four-layer structure as shown in a region 1303 with a white ink layer WL and a color ink layer CL as intermediate layers, and color ink layers CL and white ink layers WL alternately laminated. The ink layer structure may also be a five-layer structure as shown in a region 1304 with color ink layers CL and white ink layers WL alternately laminated. In the case of five or more layers, the central color ink layer CL may be black. By forming the recording medium P with a transparent material, and forming images respectively on a color ink layer CL as the undercoat layer and on a color ink layer CL as the surface layer, different images can be seen from the two sides. Note that, in an ink structure with three or more layers, an internal layer in contact with the recording medium P is an example of an undercoat layer, while an internal layer not in contact with the recording medium P is an example of an intermediate layer. Thus, in the case of three or more layers, in the color separation processing, the CPU 301 may apply settings to use the strong-reactivity reaction liquid A for ink layers that form internal layers in the laminated structure, and to use the weak-reactivity reaction liquid B for ink layers that form the surface layer. As a result, similar effects can be achieved. In other words, the present embodiment can achieve a texture of the layer that appears on the surface when observed, which blends seamlessly with the surface texture of the recording medium, which has high surface smoothness, thereby improving image quality. Although FIG. 13 shows an example in which color ink layers CL and white ink layers WL are alternately laminated, the order of lamination is not limited to this. For example, ink layers of the same type but with different amounts of reaction liquid applied may be laminated. Specifically, layers may be laminated in which the amount of reaction liquid applied to white ink layers or color ink layers is gradually increased.

### Second Embodiment

The first embodiment shows a method for achieving high surface smoothness with high affinity to the surface of the recording medium in the surface layer. The second embodiment describes an image recording method that emphasizes surface texture affinity with the recording medium for the background of a poster and visibility for the text information of the poster. The second embodiment mainly describes configurations differing from the first embodiment. As described with reference to FIGS. 4A and 4B, the transparent recording medium has high surface smoothness due to its transparency, and therefore, the white ink layer that mainly forms the background is required to have affinity with the surface texture of the recording medium. On the other hand, the color ink layer that mainly forms the foreground, such as text information, is required to ensure visibility with reduced angular dependency.

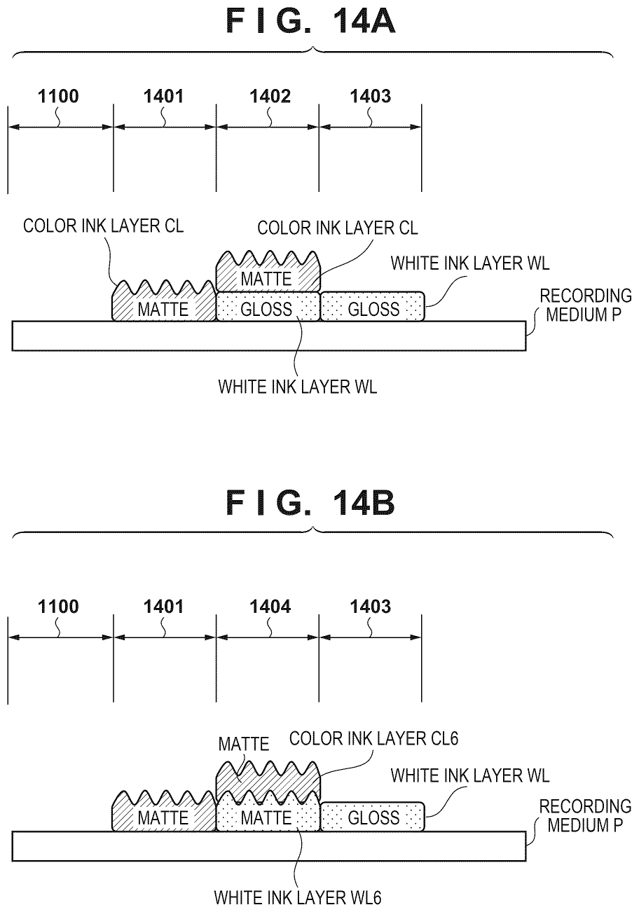

FIGS. 14A and 14B are diagrams showing the structure of the ink layer according to the second embodiment. FIG. 14A is a diagram showing the structure of the ink layer on the recording medium according to the second embodiment. The CPU 301 generates color separation data to record a gloss region 1403, composed only of the white ink layer WL as the undercoat region, with the white ink and the reaction liquid B, which induces a weak reaction. This allows the CPU 301 to enhance the surface smoothness of the white ink layer WL and make the surface glossy, thereby increasing affinity with the recording medium. On the other hand, the CPU 301 generates color separation data to record the color ink layer CL in matte regions 1401 and 1402, which are color development regions, using the color ink and the reaction liquid A, which induces a strong reaction. Thus, the CPU 301 can reduce the surface smoothness of the color ink layer CL, make the surface matte, reduce angle dependence, and improve visibility.

In the present embodiment, in the color separation processing in step S605, the CPU 301 generates multi-valued data for each recording material to record the undercoat image data with the white ink and the weak-reactivity reaction liquid B and the color development image data with the color inks and the reaction liquid A, which induces a strong reaction.

Specifically, the CPU 301 generates white ink application amount data (W_1L) and weak-reactivity reaction liquid B application amount data (RCTB_1L) from the W image data, which is the undercoat image data. The CPU 301 generates pieces of color ink application amount data (C_2L, M_2L, Y_2L, and K_2L) and strong-reactivity reaction liquid A application amount data (RCTA_2L) from the RGB image data, which is the color development image data.

Furthermore, in the pass division processing in step S608, the CPU 301 assigns ejection ports for recording color development regions and ejection ports for recording undercoat regions, and controls the recording of the reaction liquids at timings that allow the colorants of the color inks and the white ink to aggregate.

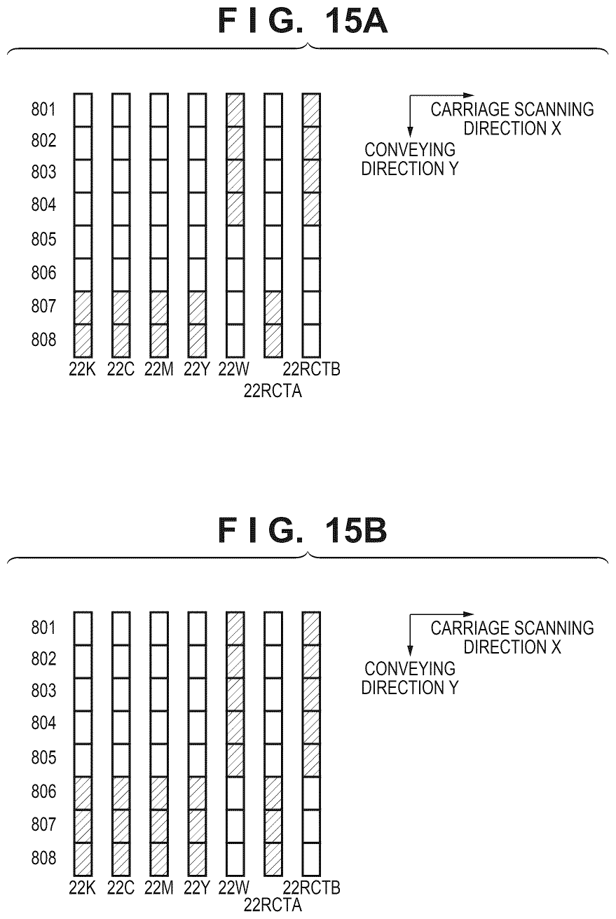

FIGS. 15A and 15B are diagrams in which examples of ejection ports that perform recording on the recording medium at least once after pass division processing are indicated by hatching.

FIG. 15A is a diagram in which examples of ejection ports that perform recording on the recording medium at least once after pass division processing are indicated by hatching. In the present embodiment, since recording is performed in multiple layers with the color inks recorded on top of the white ink, the ejection ports for recording the colorant inks (C, M, Y, and K) and the reaction liquid A (RCTA) for the color development regions, and the ejection ports for recording the colorant ink (W) and the reaction liquid B (RCTB) for the undercoat regions, are are divided into upper and lower regions as shown in FIG. 15A. In the present embodiment, the CPU 301 sets, in the pass division processing, the ejection port arrays (22W and 22RCTB) for recording the undercoat regions to perform recording using the front half of the ejection ports. The CPU 301 also sets, in the pass division processing, the ejection port arrays 22K, 22C, 22M, 22Y, and 22RCTA for recording the color development regions to perform recording using the rear quarter of the ejection portions. The CPU 301 then sets blank regions, where no recording is performed with any of the ejection port arrays, in the remaining middle quarter of the ejection ports. By applying such settings, the CPU 301 can implement processing in which, for example, in the case of recording through eight passes in total, the undercoat regions are recorded through four passes, followed by a drying period corresponding to the number of blank passes, and then the color development regions are recorded through two passes after drying. There is a concern that if the color inks are recorded immediately after the white ink, the white ink and the color inks may mix depending on the amounts of the inks. However, by providing a drying period in this way, the present embodiment makes it possible to record an image while suppressing mixing between the laminated inks.

The present embodiment, through the above-described control, can reduce the angle dependence and achieve good visibility in the color development regions of the surface layer by lowering the surface smoothness of the color inks. By increasing the surface smoothness of the white ink layer WL in the undercoat regions, it becomes possible to enhance the affinity between the exposed white ink layer WL on the surface and the recording medium.

As described above, in the second embodiment, the white ink forming the undercoat regions is recorded using the weak-reactivity reaction liquid B, while the color inks forming the color development regions are recorded using the strong-reactivity reaction liquid A. Furthermore, in the second embodiment, multi-value data for each recording material may be recorded so that, depending on the overlap between the color development image data and the undercoat image data, even the white ink is recorded using the strong-reactivity reaction liquid A.

FIG. 14B is a diagram showing another example of the ink layer structure on the recording medium according to the second embodiment. The ink layer structure shown in FIG. 14B differs from that in FIG. 14A in that, in a matte region 1404 where the color development region and the undercoat region overlap, an internal white ink layer WL6 is recorded using the white ink and the strong-reactivity reaction liquid A. Here, since the strong-reactivity reaction liquid A is applied to the white ink as well, the surface smoothness of the white ink in the matte region 1404 will be reduced. However, since a color ink surface layer CL6 is recorded with a color ink, the reduced surface smoothness of the white ink in the overlapping region does not pose a significant problem. This makes it possible to reduce the drying time needed to prevent the white ink and the color inks from mixing, thereby shortening the printing time.

In addition to the approach of reducing the number of passes by shortening the drying time, it is also possible to adopt an approach of increasing the amount of ink to be recorded while maintaining the same number of passes. FIG. 15B is a diagram in which other examples of ejection ports that perform recording on the recording medium at least once after pass division processing are indicated by hatching. Since increasing the number of passes allows for more recording operations from the ejection ports, this approach makes it possible to increase the amount of ink to be recorded.

According to the present disclosure, an image can be appropriately recorded in accordance with the viewing position or the shape of the surface of the recording medium.

### OTHER EMBODIMENTS

The ink is not limited to the white ink as long as it is used for lamination purposes, and similar effects can be achieved by applying the technique of the embodiments above to undercoat layers including metallic ink, silver ink, or gold ink.

Furthermore, although the pass masks used in the pass division processing are configured to match the number of passes between the colorant inks and the reaction liquids using pass masks, it is also acceptable to slightly advance the printing of the reaction liquids. FIG. 15C is a diagram in which other examples of ejection ports that perform recording on the recording medium at least once after pass division processing are indicated by hatching. For example, as shown in FIG. 15C, the CPU 301 may also perform pass division processing using pass masks in which 4 passes are assigned to the white ink for the undercoat regions, 5 passes are assigned to the weak-reactivity reaction liquid B, 2 passes are assigned to the color inks for the color development regions, and 3 passes are assigned to the strong-reactivity reaction liquid A.

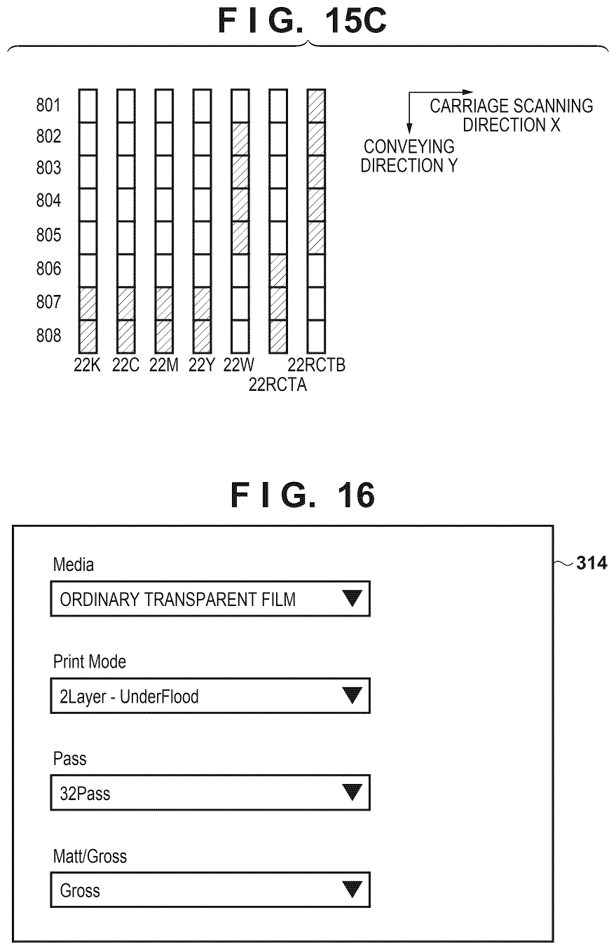

The technique according to the present embodiment may also be applied to other uses in which white ink is used not as a background but as content such as text. FIG. 16 is a diagram showing the UI screen 314 of an application executed by the computer 312. A processor 171 of the computer 312 may display the UI screen on the display unit 178 to receive user selections of a recording medium, a printing mode such as single-layer printing or multi-layer printing, and the number of passes, and may further receive a selection of selection modes including a matte mode and a gloss mode. The processor 171 transfers the information received from the user to the recording apparatus 100. The CPU 301 of the main control unit 300 in the recording apparatus 100 switches between the reaction liquids to be recorded on the white ink layer based on the selection information transferred from the computer 312, thereby making it possible to provide the surface smoothness of the white ink according to the intended use. Specifically, when printing white content, the CPU 301 selects the matte mode to record it using the white ink and the strong-reactivity reaction liquid A. On the other hand, when printing white as a background, the CPU 301 selects the gloss mode to record it using the white ink and the weak-reactivity reaction liquid B. By controlling in this way, recording can be performed according to the intended use.

The processor 171 may also display a UI screen to switch between modes according to the user's intended use, such as a photo mode and a poster mode. For example, in the photo mode, since both the white ink and the color inks are part of the photograph, the CPU 301 may perform control so that all colors have a glossy finish by using the reaction liquid B (RCTB) for the surface layer, as in the first embodiment. On the other hand, in the poster mode, the CPU 301 may perform control so that the color inks, used for the color development regions (foreground), are finished with a matte appearance by using the reaction liquid A (RCTA), while the white ink, used for the undercoat region (background), is finished with a glossy appearance to emphasize affinity with the recording medium, as in the second embodiment. In this way, the processor 171 can further improve user convenience by displaying a UI screen that allows a mode to be set according to the user's intended printing application.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-106279, filed Jul. 1, 2024, which is hereby incorporated by reference herein in its entirety.

What is claimed is:

1. An image processing apparatus comprising:
at least one memory storing instructions; and
at least one processor, that upon execution of the stored instructions, is configured to operate as:
an acquisition unit configured to acquire data of an image; and
a generation unit configured to generate color separation data based on the data of the image, the color separation data being used to record the image using a first ink for forming a surface layer of the image, a first reaction liquid that reacts with the first ink, a second ink for forming an undercoat layer of the image, and a second reaction liquid that has a different reactivity from the first reaction liquid and reacts with the second ink.

2. The image processing apparatus according to claim 1,
wherein the generation unit generates the color separation data such that the surface layer includes the first reaction liquid and the undercoat layer includes the second reaction liquid.

3. The image processing apparatus according to claim 1,
wherein the first ink and the second ink each contain a colorant, and
the first reaction liquid and the second reaction liquid do not contain a colorant.

4. The image processing apparatus according to claim 1, the processor, that upon execution of the stored instructions, is configured to further operate as:
a pass division processing unit configured to perform pass division processing to set ejection ports that eject the first ink, the second ink, the first reaction liquid, and the second reaction liquid.

5. The image processing apparatus according to claim 1,
wherein the generation unit generates the color separation data in which an application amount of the first ink and an application amount of the first reaction liquid corresponding to the application amount of the first ink are set for the surface layer.

6. The image processing apparatus according to claim 1,
wherein the generation unit generates the color separation data such that the undercoat layer has a lower surface smoothness than the surface layer.

7. The image processing apparatus according to claim 1,
wherein the generation unit generates the color separation data such that the undercoat layer has a higher surface smoothness than the surface layer.

8. The image processing apparatus according to claim 1,
wherein the generation unit applies settings to use
a color ink as the first ink, and
at least a white ink as the second ink.

9. The image processing apparatus according to claim 1,
wherein the generation unit generates the color separation data for ejecting the first reaction liquid, which reacts with the second ink, into a region where the second ink is to be ejected, within a region where the surface layer and the undercoat layer are laminated.

10. The image processing apparatus according to claim 1,
wherein the generation unit generates the color separation data for switching combinations of the first and second inks with the first and second reaction liquid.

11. The image processing apparatus according to claim 1,
wherein the generation unit generates the color separation data that contains data on the first and second reaction liquids generated based on attribute data indicating the surface layer and the undercoat layer.

12. The image processing apparatus according to claim 11,
wherein the generation unit generates the color separation data to eject the second reaction liquid onto the surface layer and the first reaction liquid onto the undercoat layer, based on the attribute data.

13. The image processing apparatus according to claim 1,
wherein the generation unit generates the color separation data such that, in the surface layer including a gloss region and a matte region, the first reaction liquid is ejected into the gloss region and the second reaction liquid is ejected into the matte region.

14. The image processing apparatus according to claim 1,
the generation unit generates the color separation data including
data on application amounts of the first ink and the first reaction liquid to be ejected onto the surface layer, and
data on application amounts of the second ink and the second reaction liquid to be ejected onto the undercoat layer.

15. The image processing apparatus according to claim 1,
wherein, when the undercoat layer is partially exposed from the surface layer, the generation unit generates the color separation data such that the second ink, the second reaction liquid, and the first reaction liquid are to be ejected onto the undercoat layer.

16. The image processing apparatus according to claim 1,
wherein, when the undercoat layer is entirely exposed, the generation unit generates the color separation data such that at least the first reaction liquid is to be ejected onto the second ink of the undercoat layer.

17. The image processing apparatus according to claim 1,
wherein, when the undercoat layer is partially exposed from the surface layer, the generation unit generates the color separation data including application amounts of the first reaction liquid and the second reaction liquid in accordance with a surface dominance ratio indicating a ratio of exposure between the surface layer and the undercoat layer.

18. The image processing apparatus according to claim 1,
wherein, when the image includes an intermediate layer between the undercoat layer and the surface layer, the generation unit generates the color separation data such that the intermediate layer has a lower surface smoothness than the surface layer.

19. A recording apparatus comprising:
the image processing apparatus according to claim 1; and
a recording head having ejection ports configured to eject the first ink, the second ink, the first reaction liquid, and the second reaction liquid.

20. A non-transitory computer-readable storage medium storing a computer program that, when read and executed by a computer, causes the computer to function as:
an acquisition unit configured to acquire data of an image; and
a generation unit configured to generate color separation data based on the data of the image, the color separation data being used to record the image using a first ink for forming a surface layer of the image, a first reaction liquid that reacts with the first ink, a second ink for forming an undercoat layer of the image, and a second reaction liquid that has a different reactivity from the first reaction liquid and reacts with the second ink.

21. An image processing method comprising:
acquiring data of an image; and
generating color separation data based on the data of the image, the color separation data being used to record the image using a first ink for forming a surface layer of the image, a first reaction liquid that reacts with the first ink, a second ink for forming an undercoat layer of the image, and a second reaction liquid that has a different reactivity from the first reaction liquid and reacts with the second ink.
